(19) United States
(12) Patent Application Publication
(10) Pub. No.: US 2025/0284270 A1
(43) Pub. Date: Sep. 11, 2025

(54) SYSTEMS AND METHODS FOR COMBINING THERMAL SIMULATIONS WITH SENSOR DATA TO DETECT FLAWS AND MALICIOUS CYBER INTRUSIONS IN ADDITIVE MANUFACTURING

(71) Applicant: NUtech Ventures, Lincoln, NE (US)

(72) Inventors: Reza YAVARI, Lincoln, NE (US); Prahalada RAO, Lincoln, NE (US); Alex RIENSCHE, Lincoln, NE (US); Kevin D. COLE, Lincoln, NE (US)

(21) Appl. No.: 18/690,954

(22) PCT Filed: Sep. 1, 2022
(86) PCT No.: PCT/US2022/042359

§ 371 Date: Mar. 11, 2024

Related U.S. Application Data
(60) Provisional application No. 63/242,860, filed on Sep. 10, 2021.

(51) Int. Cl. G05B 19/418

(52) U.S. Cl. CPC G05B 19/41875; G05B 2219/32194; G05B 2219/49023

(57) ABSTRACT

Described herein are systems and methods for detecting flaws during an additive manufacturing (AM) process. A method can include accessing, by a computer, simulation results of a computer-modelled part representing a physical part to be formed using the AM process. The simulation includes a thermal history model for the computer-modelled part. During run-time formation of the physical part, the method includes receiving, from sensor devices, real-time sensor data of temperature values for nodes within regions of the physical part as each region is formed. The method also includes determining, for each region as the region is formed in the physical part, a deviation between the real-time sensor data of temperature values for nodes within the region and temperature values of the thermal history model for the computer-modelled part, and identifying flaws in the physical part based on determining that the deviation satisfies criteria indicating a flaw.

### CROSS-REFERENCE TO RELATED APPLICATIONS

This application is a 35 U.S.C. § 371 Application from PCT/US2022/042359 filed Sep. 1, 2022, which claims the benefit of priority under 35 U.S.C. § 119 to U.S. Provisional Application Ser. No. 63/242,860, filed Sep. 10, 2021, the entireties of which are incorporated herein by reference.

### STATEMENT OF FEDERALLY SPONSORED RESEARCH

This invention was made with government support under CMMI1752069 and OIA1929172 awarded by the National Science Foundation. The government has certain rights in the invention.

### TECHNICAL FIELD

This document describes devices, systems, and methods related to detecting incipient flaw formation in parts that are generated during an additive manufacturing process.

### BACKGROUND

Additive manufacturing processes can be used to build stronger, more durable parts in a timely and efficient manner. During an additive manufacturing process, however, parts can be formed with flaws. Despite considerable cost and time savings, precision-driven industries, such as aerospace and biomedical, are hesitant to use additive manufacturing techniques, such as laser powder bed fusion (LPBF), to make safety-critical parts due to the tendency of these techniques to create flaws. Moreover, the additive manufacturing process can include cyber security threats. Malicious actors may plant hidden flaws in a part to compromise its performance. For example, a void can be planted inside a functionally critical feature of a part during the design process by altering the .stl file or by tampering with the processing conditions. As a result, the part can be compromised.

### SUMMARY

The document relates to flaw-free production of parts using additive manufacturing processes, such as LPBF. More particularly, the disclosed techniques can provide a physics-based strategy to detect incipient flaw formation in LPBF parts resulting from processing anomalies, machine faults, and deliberate intrusions. Flaws generated during the LPBF printing process can be detected by pairing a graph theory thermal simulation with in-line thermal measurements. The simulation can utilize a configurable node-based architecture to approximate thermal diffusion and steady state within the part. The thermal history during the printing process (e.g., in-line thermal measurements) can be incorporated into the simulation to refine anticipated data/output from the simulation for the particular model that is being built. Fault detection can occur when significant deviations between the predicted history and actual history of thermal measurements are detected by thermal sensors.

The disclosed techniques include monitoring temperature distribution (e.g., thermal history) of a part as it is being printed by complementing predictions from a computational thermal model for the part with in-process meltpool temperature data. As a result, part flaws formed during LPBF can be identified in real-time with greater clarity and interpretability when temperature predictions from a thermal model are combined (e.g., twinned) with real-time data from in-process sensors, as opposed to analysis of sensor data alone.

Combining the simulation of a thermal model with analysis of temperature sensor data can be considered a digital twin approach to additive manufacturing. The digital twin approach can be demonstrated through four exemplary tasks: (1) four stainless steel (316L) practical impeller-shaped LPBF test parts can be built simultaneously on a commercial LPBF system (e.g., EOS M290 or other similar systems), and the build time can be close to 16.5 hours. Three types of flaws can be induced in these parts. First, three of the four impellers can be built under sub-optimal processing conditions to emulate flaw formation caused due to process drifts. Second, certain regions within these impellers can be embedded with voids of various sizes to mimic flaws implanted by malicious actors. Third, the laser processing optic can be degraded to affect process performance. (2) As the impellers are being printed, real-time measurements from the meltpool region can be acquired using a commercial sensing array consisting of three pyrometers located coaxial to the laser path. One or more other sensor devices and/or arrays of sensors can be utilized. (3) The thermal history of the impellers can be predicted using a rapid, mesh-free simulation approach based on graph theory. This approach can predict the thermal history within approximately five minutes. (4) For online detection of flaw formation, a real-time process monitoring approach can be developed. The graph theory thermal predictions can be updated based on real-time streaming sensor data (e.g., signatures). As a result, the digital twin approach incorporating both theoretical predictions and in-process sensor signatures can detect onset of the three types of flaw formation mentioned above in a timely and accurate manner. The disclosed techniques can also be used to detect one or more other types of flaw formations when parts are formed using additive manufacturing techniques.

In addition to the embodiments of the attached claims and the embodiments described above, the following numbered embodiments can also be innovative.

Embodiment 1 is a computer-implemented method for detecting flaws during an additive manufacturing process, the method comprising: accessing, by a computing system, results of a simulation of a computer-modelled part representing a physical part to be formed using the additive manufacturing process, wherein the simulation of the computer-modelled part comprises generated a thermal history model for the computer-modelled part, during a run-time formation of the physical part by the additive manufacturing process, receiving, by the computing system and from one or more sensor devices, real-time sensor data of temperature values for nodes within a plurality of regions of the physical part that is formed using the additive manufacturing process as each of the plurality of regions is formed for the physical part, the regions of the physical part each having densities of the respective nodes, wherein the plurality of regions of the physical part correspond to respective regions of the computer-modelled part, determining, by the computing system and for each region of the plurality of regions of the physical part as the region is formed in the physical part, a deviation between the real-time sensor data of temperature values for the nodes within the region of the physical part and temperature values of the thermal history model for the computer-modelled part, and identifying, by the computing system, one or more flaws in the physical part based on determining that the deviation satisfies criteria indicating a flaw.

Embodiment 2 is the method of embodiment 1, wherein the simulation of the computer-modelled part included a computer performing the following: accessing, by the computer, the computer-modelled part representing the physical part to be formed using the additive manufacturing process, populating, by the computer, first nodes within a first region of the computer-modelled part with temperature values, such that each of the first nodes has a corresponding temperature value, the first region of the computer-modelled part having a first density of the first nodes, the first region of the computer-modelled part being proximal a surface of the computer-modelled part at which material is added to the computer-modelled part during a simulation of the additive manufacturing process, populating, by the computer, second nodes within a second region of the computer-modelled part with temperature values, such that each of the second nodes has a corresponding temperature value, the second region of the computer-modelled part having a second density of the second nodes that is less than the first density of the first nodes in the first region of the computer-modelled part, the second region of the computer-modelled part being distal the surface of the computer-modelled part at which material is added to the computer-modelled part during the simulation of the additive manufacturing process, removing, by the computer, first nodes from part of the first region that is proximate the second region of the computer-modelled part, so that the part of the first region that is proximate the second region becomes part of the second region and has the second density of nodes, simulating, by the computer as part of the simulation of the additive manufacturing process, adding material on the surface of the computer-modelled part to form a new layer of the computer-modelled part, the new layer of the computer-modelled part being part of the first region and having first nodes that are distributed according to the first density, populating, by the computer, the first nodes within the new layer of the computer-modelled part with temperature values, such that each of the first nodes within the new layer of the computer-modelled part has a corresponding temperature value, and generating, by the computer, the thermal history model for the computer-modelled part, wherein the thermal history model includes the temperature values for each of the first and second nodes in the regions of the computer-modelled part.

Embodiment 3 is the method of any one of embodiments 1 and 2, wherein the additive manufacturing process comprises a laser powder bed fusion (LPBF) additive manufacturing process.

Embodiment 4 is the method of any one of embodiments 1 through 3, wherein the real-time sensor data includes one or more temperature values of a laser-material interaction zone of the physical part.

Embodiment 5 is the method of any one of embodiments 1 through 4, wherein the one or more sensor devices include an array of photodetectors located co-axial to a path of a laser that is used to build the physical part during the additive manufacturing process.

Embodiment 6 is the method of any one of embodiments 1 through 5, wherein at least one of the first region, the second region, and the new layer of the computer-modelled part is (i) a location without artificially planted flaws, (ii) a location where artificial flaws were planted, or (iii) a location where lens delamination was suspected.

Embodiment 7 is the method of any one of embodiments 1 through 6, wherein the thermal history model of the computer-modelled part represents temperature values of the computer-modelled part when the computer-modelled part is in a flaw-free condition.

Embodiment 8 is the method of any one of embodiments 1 through 7, wherein the temperature value for each of the first and second nodes is an instantaneous meltpool temperature for the computer-modelled part.

Embodiment 9 is the method of any one of embodiments 1 through 8, wherein the real-time sensor data includes output temperature values detected by the one or more sensor devices a threshold period of time after a laser strikes the physical part.

Embodiment 10 is the method of any one of embodiments 1 through 9, wherein the threshold period of time is 0.1 seconds.

Embodiment 11 is the method of any one of embodiments 1 through 10, wherein the computer-modelled part and the physical part are a same shape.

Embodiment 12 is the method of any one of embodiments 1 through 11, further comprising updating, by the computing system, temperature values in the thermal history model of the computer-modelled part at one or more of the regions in the computer-modelled part with the real-time sensor data of corresponding one or more of the plurality of regions in the physical part.

Embodiment 13 is a computerized system comprising one or more processors and one or more computer-readable devices including instructions that, when executed by the one or more processors, cause the computerized system to perform operations that include performing the method of any one of the embodiments 1 through 12.

The devices, system, and techniques described herein may provide one or more of the following advantages. For example, the disclosed techniques provide for timely and accurate detection of flaw formation as parts are being generated during the additive manufacturing process. Thermal and positional data can also allow for processing anomalies to be identified and located without extensive post-production analysis. The disclosed techniques also allow for immediate recognition of complex fault formations in parts as they are being made in real-time. The disclosed techniques can also be used to identify and detect cyber security threats.

The disclosed techniques also reduce computation time. Compared to existing modeling techniques, there can be a five to ten times reduction in processing time to detect flaw formation during LPBF or other metal powder printing processes in additive manufacturing.

Moreover, the disclosed techniques can be adaptable. Flaw causation classification resulting from the disclosed techniques can be possible from one algorithm and/or process.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a schematic diagram of an LPBF process.

FIG. 2 illustrates some causes for flaw formation in LPBF.

FIG. 3 illustrates the digital twin approach applied to practical impeller-shaped parts.

FIG. 4 illustrates an organization of the present disclosure.

FIG. 5 depicts four example, identical stainless steel impeller-shaped parts (e.g., Impellers I, II, III, and IV) that were simultaneously built using the disclosed techniques.

FIG. 6 depicts case 1, in which the four impellers of FIG. 5 are produced under different laser power conditions to mimic an effect of process drifts.

FIG. 7 illustrates artificial flaws introduce into three of the four impellers.

FIG. 8 is a graph depicting time between layers (e.g., inter-layer time) of the four impellers of FIG. 5.

FIG. 9 depicts X-ray CT images of two quarter-sections of each of the four impellers that demonstrate a marked difference in porosity.

FIG. 10 depicts an effect of change in processing conditions on microstructure and porosity of the impellers.

FIG. 11 is a schematic diagram of an example LPBF machine and an on-axis sensing setup that can be used with the disclosed techniques.

FIG. 12 is a conceptual diagram for measuring emissions from a meltpool region of an impeller using a bandpass filtered photodetector.

FIG. 13 depicts example Thermal Energy Planck (TEP) sensor measurements consolidated in a 2D color-scaled image for all four impellers of FIG. 5.

FIG. 14 depicts spatial regions where sensor data can be acquired in the impellers of FIG. 5.

FIG. 15 includes graphical depictions of TEP signatures for Impeller I and TEP data for Impellers II, III, and IV.

FIG. 16 includes graphical depictions of Thermal Energy Density (TED) photodetector responses for each of the impellers.

FIG. 17 includes graphical depictions of effects of planted flaws on TEP and TED measurements relative to trends for a flaw free region of an impeller.

FIG. 18 is a representative 2D TEP measurements for six layers of Impeller III.

FIG. 19 includes graphical depictions comparing TEP and TED measurements sampled at flaw-free regions and at regions with lens delamination.

FIG. 20 is a conceptual diagram depicting thermal phenomena in LPBF extended past multiple scales.

FIG. 21 is a schematic diagram depicting four steps in the graph theory approach used in the disclosed techniques.

FIG. 22 depicts the two phases of the digital twin approach for detecting flaw formation.

FIG. 23 includes graphical depictions of thermal simulation of a part with input from a TEP sensor.

FIG. 24 includes graphical depictions of thermal history of an entire part sampled at 0.1 seconds after a laser strikes the part and at the end-of-cycle temperature.

FIG. 25 depicts a comparison of simulation results when using instantaneous temperature and the end-of-cycle temperature.

FIG. 26 includes graphical depictions of convergence with effect of node density with super layer thickness fixed at 0.25 mm and effect of super layer thickness with node density fixed at 0.5 nodes·m⁻³.

FIG. 27 depicts graph theory-derived thermal history predictions compared with commercial Netfabb output.

FIG. 28 includes graphical depictions of thermal history for the four impellers of FIG. 5 when instantaneous surface temperature is sampled versus when end-of-cycle temperature is sampled.

FIG. 29 is a graphical depiction of temperature deviations from the nominal Impeller 1 as used to detect process drifts and embedded flaws.

FIG. 30 includes graphical depictions of temperature response for Impellers II and III sampled at sections where flaws were planted.

FIG. 31 is a graphical depiction demonstrating a large deviation from nominal temperature trends as observed in a region where flaws are embedded in the Impellers II and III.

FIG. 32 includes graphical depictions of thermal history trends for Impeller III sampled from a lens delamination region compared to thermal history trends for a flaw-free region.

FIG. 33 is a schematic diagram that shows an example of a computing device and a mobile computing device.

Like reference symbols in the various drawings indicate like elements.

### DETAILED DESCRIPTION OF ILLUSTRATIVE EMBODIMENTS

This document relates to use of in-line thermal monitoring coupled with thermal modeling to detect flaw formation in additive manufacturing processes, such as LPBF and other metal powder printing processes (e.g., digital twin approach). The disclosed techniques therefore provide a computer system where a generalized simulation of building a part is produced before a printing (e.g., manufacturing) process, then during the printing process, sensing inputs are collected and used with the simulation to detect flaw formation in the part and to correct the printing process.

### Section 1: Introduction

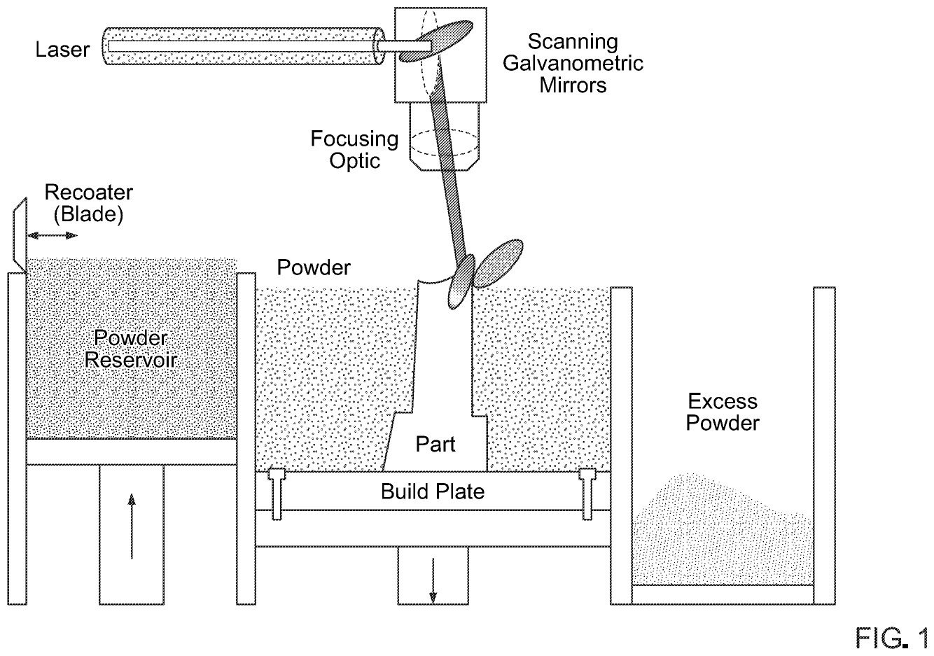

Referring to the figures, FIG. 1 is a schematic diagram of an LPBF process. Layers of powder can be raked on a build plate and melted with thermal energy of a layer. This disclosure can provide for flaw-free production of parts made using the LPBF additive manufacturing process or other additive manufacturing processes. In LPBF, layers of metal powder can be selectively melted using thermal energy from a rapidly scanning laser. Typically, an infrared solid-state laser (e.g., Nd: YAG or YAG) with power set between 200 to 300 W, and scanning speed from 300 mm·s⁻¹ to 500 mm·s⁻¹ can melt thin layers of powder (30 μm to 50 μm) that can be raked onto the build plate by a recoater blade. The laser can be translated with a pair of scanning galvanometric mirrors and focused onto the powder bed with an optical lens (f-θ lens can be used).

The LPBF process can create complex geometries that may be difficult, if not impossible, to manufacture using conventional subtractive and formative processes. Despite its ability to transcend design and manufacturing barriers, and reduce cost and lead times, the use of LPBF in safety-critical industries may be limited due to tendency of the process to create flaws, such as non-uniformity of microstructure, lack-of-fusion, gas porosity, and distortion in shape.

In LPBF, rapid scanning action of the laser can lead to temperature cycles nearing 10⁶° C.··s⁻¹ and continual deposition of material at high temperature may cause steep temperature gradients in preceding layers. The rapid heating and cooling of the part during the process, called thermal history, can be causally linked to flaw formation. The thermal history of the part can be a function of multiple factors, including processing parameters, shape of the part, presence of supports used to anchor the part, material properties, as well as location and presence of other parts on the build plate.

Hence, to ensure quality assurance, there can be a need for fast and accurate simulations to predict the thermal history of part as function of the multitude of factors. Such process simulations can be important to (i) physics-based design and optimization of process parameters to replace expensive build-and-test empirical optimization, (ii) predict residual stresses (deformation in shape), microstructure evolved, and physical properties of the part as a function of the thermal history, and (iii) model-based real-time monitoring and control with the aid of in-process sensor data to identify and correct incipient flaw formation.

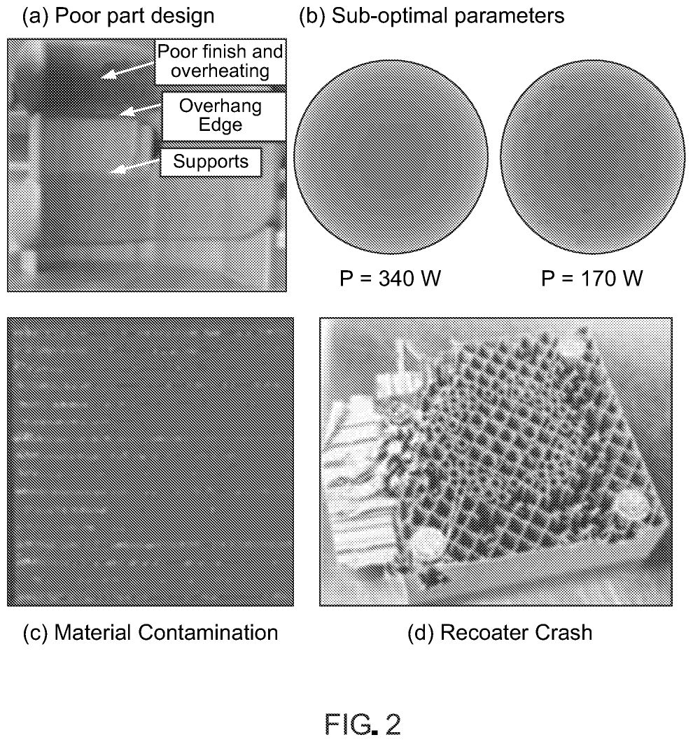

FIG. 2 illustrates some causes for flaw formation in LPBF. Flaw formation in LPBF parts can be liable to occur on account of one or more reasons, such as the 6 reasons exemplified in FIG. 2, a majority of which can be closely coupled to the thermal history of the parts. Some causes for flaw formation in LPBF include (a) overheating of a knee implant due to inadequate supports, (b) reduction in laser power leading to lack-of-fusion porosity, (c) contamination of Inconel feedstock with tungsten particles, and (d) recoater crash.

First, with regards to part design, support structures, and part orientation, a shape and orientation of the part can determine the thermal history, and thus can influence the part properties. Certain features such as thin walls and overhang regions can accumulate heat, and cool more slowly compared to other features. The uneven heating and cooling of the part during the process can cause flaws, such as nonuniformity of microstructure and thermal-induced cracking.

Likewise, pragmatic placement of supports can be critical for preventing part features, such as overhangs and cavities from collapsing. Additionally, supports can act as pathways to conduct heat that can be liable to accumulate in overhang and thin cross-sections (thermal supports).

For example, shown in FIG. 2(a) is a LPBF-processed knee implant. The overhang region of the knee implant can be observed to have poor surface finish and coarse microstructure owing to heat retention. These overheating can be mitigated by increasing the cross-section area of the supports.

Second, location of the part on the build plate relative to others can influence the order of melting, generation of spatter, and interaction with the laser and process gasses, among others. For example, parts placed near edges of the build plate can be afflicted with flaws due to limitations in optics. Further, removing or adding parts to a build plate can alter an amount of time to process a layer, thus changing the cooling behavior and the thermal history, and consequently, the microstructure and flaw formation of all parts on the build plate.

Third, with regards to poor choice of processing parameters, the LPBF process can have over 30 process variables, including laser power, velocity, scanning pattern, time between layers, material properties, etc., all of which can directly influence the thermal history, and subsequently, flaw formation. The effect of processing parameters on flaw formation is depicted in FIG. 2(b). When processing a titanium alloy cylinder, reducing the laser power can lead to insufficient material consolidation (lack-of-fusion flaw). The large parameter space of LPBF may be difficult, if not impossible, to optimize using empirical means.

Moreover, in LPBF, a set of parameters that are optimized based on an empirical build-and-test strategy of simple shaped test coupons may not be generalizable for practical, complex shapes, because, the thermal history may be influenced not only by the processing parameters, but as explained previously, the shape of the part, placement of supports, and part location. Hence, a set of parameters optimized from empirical testing of exemplar shapes may not be generalizable to all shapes.

Fourth, with regards to gas entrapment, impurities, and inconsistences in feedstock powder material, feedstock powder material may have gases trapped inside the particles from their manufacturing process (gas atomization). These entrapped gasses in the powder can be liable to be released on account of high temperature resulting from heat accumulation. The flaws formed due to escaping gasses from the powder can be linked to a type of porosity called gas-induced porosity.

The powder may also become contaminated during changeover by residue from previous builds, moisture and impurities during handling. Thus, the powder may show large variation in particle size and shape. Such inconsistencies can be liable to cause flaw formation.

Fifth, with regards to process faults (drifts) caused by change in parameters and machine failures, the LPBF process settings can drift (vary) during the process. For example, during the LPBF process, the rapid melting of the material can release moisture and soot. These byproducts can accumulate on a focusing optic of the machine. The occlusion of the lens can result in aberrations in the laser focus, which can have the effect of reducing the incident energy leading to material consolidation errors. Long builds can therefore be prone to flaw formation. Other examples of a machine-related failure can include recoater crashes and failure of supports caused on account of excessive deformation of the part resulting from thermal-induced residual stresses. For example, the part shown in FIG. 2(d) deformed as a consequence of residual stresses. This deformation caused interference with the motion of the recoater, resulting in damage to the part.

Sixth, with regard to intrusions with intent to alter the printing process or part design, malicious intrusions can occur in real-time during the process as the part is being printed, or during the design and transfer of the .stl model of the part from a CAD computer terminal to the machine. For example, the functional properties of the part, such as its strength and fatigue life, can be imperiled by surreptitiously incorporating voids in key part features during the printing process.

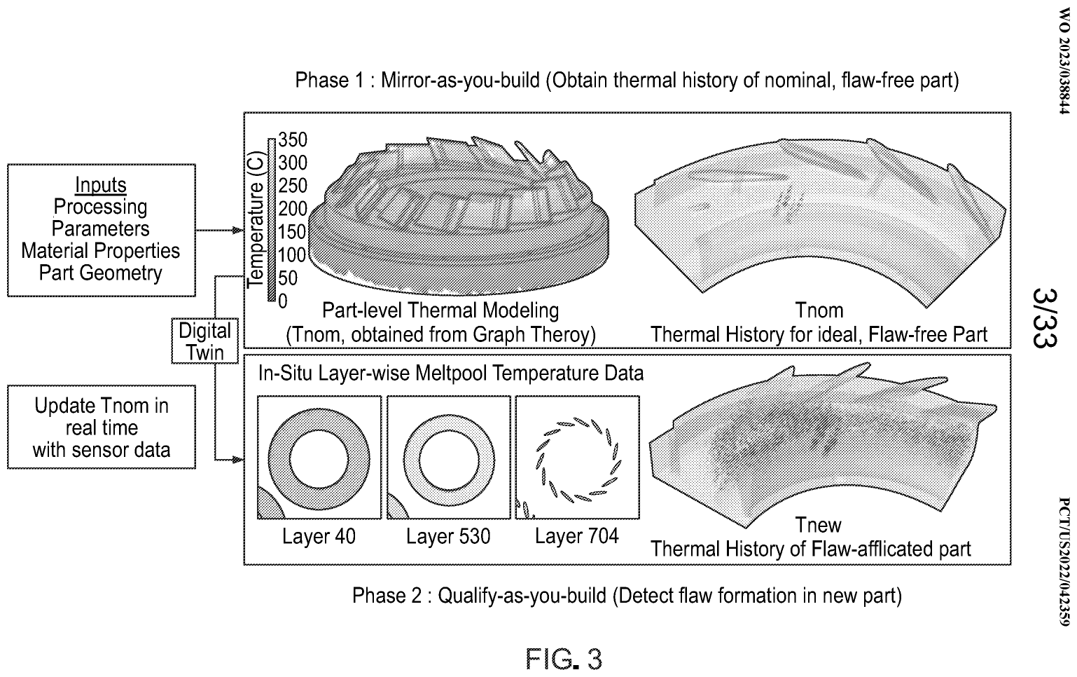

FIG. 3 illustrates the digital twin approach applied to practical impeller-shaped parts. As described herein, the approaches includes two phase. In Phase I, called the mirror-as-you-build phase, the part-level thermal history for a flaw-free impeller can be predicted using a graph theory. In Phase II, the qualify-as-you-build phase, the thermal history of a new part can be obtained and monitored by updating the thermal history of a nominal part with in-situ real-time sensor data.

The digital twin approach and apply a physics-aided strategy to detect incipient flaw formation in LPBF parts. Flaw formation during LPBF can be captured in a timely and compelling manner when predictions from physics-based models are combined (e.g., twinned) with real-time data from in-process sensors in contrast to analysis of sensor data alone (e.g., data-driven modeling, black-box modeling).

The term digital twin in the LPBF context can be used herein to refer to coupling of physics-based models that predict the thermal history of the part during the process, with real-time sensor data for flaw detection. The digital twin approach is illustrated in the below disclosure by detecting onset of three different types of LPBF flaw formation aspects in complex stainless steel (e.g., 316L) impeller-shaped parts built using an LPBF machine (e.g., EOS M290 commercial machine or other similar machines).

This disclosure therefore provides for real-time detection of part flaws by integrating (e.g., twinning) meltpool-level process signatures acquired from multiple sensors with ab-initio thermal modeling based on graph theory. The meltpool can be a region of melted material resulting from interaction of a laser and powder material. A key attribute of the approach, as shown in FIG. 3, is that the thermal modeling and process monitoring steps are not decoupled. Instead, the streaming meltpool-level sensor data can be used as an input to the thermal model. Consequently, the model predictions can be updated in real-time based on streaming sensor data to detect flaw formation.

The concept of the digital twin approach to capture the onset of flaw formation, delineated in FIG. 3 consists of two phases: Phase 1-mirror-as-you-build, and Phase II-qualify-as-you-build. An analogy of the approach can be made with terminology of statistical process control. Phase I encapsulates a common cause variation by quantifying thermal history of a part in its flaw-free state or nominal state. The thermal history of the nominal, flaw-free state (Tₙₒₘ) can represent variations in part temperature on account of change in shape of the part as it is being printed along with inherent (white) noise in the process.

Phase II, called qualify-as-you-build, can detect flaw formation in a new part of the same shape (e.g., Phase II captures special cause variation). These flaws can be captured by comparing its thermal history of a new part (T_{new}) to that of a nominal, flaw-free part Tₙₒₘ from Phase I. A large deviation in T_{new} from Tₙₒₘ can be symptomatic of flaw formation.

The realization of the digital twin approach can hinge on seamless integration of two aspects: (i) rapid thermal modeling, and (ii) real-time model update based on in-situ temperature data. To explain further, for the digital twin approach to be feasible thermal history can be predicted well within an amount of time it takes to build the part. Additionally, the model can be updated in real-time based on streaming sensor data.

In Phase I, the thermal history (Tₙₒₘ) of the LPBF part created under ideal conditions can be predicted using a graph theory-based computational thermal modeling approach. The graph theory approach can be 5 to 10 times faster than finite element modeling, with error being less than 5% when compared to experimental data. In Phase II, the thermal history of a new part (T_{new}) can be estimated layer-by-layer by updating the thermal history of the ideal, flaw-free part (Tₙₒₘ) in real-time with streaming in-process signatures. The sensor data can be temperature of the laser-material interaction zone (meltpool) obtained from an array of photodetectors located co-axial to the laser path.

As described below, three types of flaws can be identified using the disclosed techniques (e.g., the digital twin approach). Case 1 is to induce flaws resulting from process drifts or process faults. These can be changes in processing conditions, where the laser power can be increased or decreased from a nominal setpoint. This change in laser power can result in flaws, such as lack-of-fusion (porosity) and non-uniformity of microstructure in the parts. Case 2 is to simulate malicious intrusions and implanted flaws, which can refer to flaws that are deliberately placed in certain sections of the part. A number of spherical voids of diameter varying from 0.50 mm to 0.030 mm can be placed within the impeller in an example test of the digital twin approach. Case 3 can be to cause flaw formation due to faults in the machine parts, which can be produced with a degraded optical coating of the f-θ focusing lens (e.g., lens delamination).

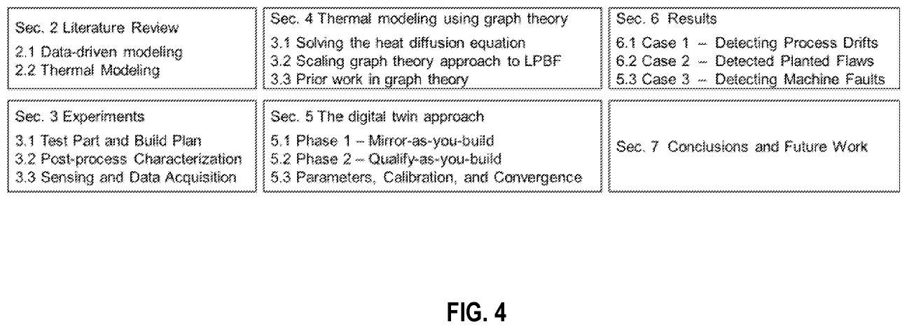

FIG. 4 illustrates an organization of the present disclosure. This disclosure can be considered in 6 parts. In Sec. 2, challenges in applying a purely physics-based or data-driven modeling strategy for process monitoring in LPBF are discussed. Sec. 2 also summarizes challenges in terms of data-driven flaw monitoring and part-level thermal modeling in LPBF as well as some examples in the digital twin of additive manufacturing that can be used to overcome the foregoing challenges.

Sec. 3 details the experimental procedure, including the design and manufacturing of four impeller-shaped parts and their build plans. This section also describes build strategies to mimic flaw formation resulting from process drifts, deliberate intrusions, and machine faults. Additionally, detailed in Sec. 3 is a post-process analysis of the parts flaws using non-destructive X-ray computed tomography, and destructive materials characterization (optical microscopy, scanning electron microscopy, and electron beam backscatter diffraction). Sec. 3 closes with description of the sensing array and representative in-process data. Sec. 4 details the graph theory approach for thermal modeling in LPBF. Sec. 5, describes the digital twin approach for combining thermal simulations with in-process sensor data for detecting flaw formation in LPBF. The results from applying the digital twin to detect flaw formation in impeller-shaped parts is described in Sec. 6. Finally, conclusions and avenues for future work are summarized in Sec. 7.

### Section 2: Literature Review

There are some limitations and challenges of using data-driven modeling for flaw monitoring in LPBF and computational constraints with existing finite element-based thermal models that can limit their coupling with sensor data for real-time flaw detection. The digital twin approach described herein can overcome these constraints, in the following manner. The graph theory approach used, as described throughout, not only can converge magnitude faster than finite element models but can also allow explicit integration and update of thermal trends based on real-time process data.

A purely data-driven approach for in-process quality monitoring in LPBF can result in (i) poor generalizability of data-driven models to different shapes even for the same material; (ii) lack of physical interpretability to explain the predicted trends and real-time visual accessibility; and (iii) difficulty in using sensor data for process correction. Poor generalizability of data-driven process monitoring for LPBF can occur for two reasons. First, the thermal history can be a function of multiple interlinked factors, such as part shape, location, orientation and process parameters. Hence, models trained based on simple shapes may lead to large false alarm and failure to detect rates when used with different part shapes, even shapes that are composed of the same material. Second, while data-driven machine learning models can be used for flaw detection in LPBF, these models can require a relatively large volume of input-output pairs, which can be prohibitively expensive to acquire, given the small batch sizes and high cost of raw (powder) material. To explain further, data-driven models, such as neural networks, can learn to detect flaw formation from sensor data. Such data sets, which can include in-situ measurement of the meltpool temperature using a pyrometer and part-level temperature such as infrared thermal camera, to name a few, can be acquired from experiments with rudimentary cuboid and cylindrical test coupons whose cross section may not change drastically during the process. Next, to provide labeled inputs to machine learning, it can be necessary to ascertain location and nature of flaw formation. For this purpose, the part can be examined using destructive metallographic analysis or non-destructive analysis, such as X-ray CT, both of which can be costly and time prohibitive. Lastly, online identification of a defect from sensor data remains in its infancy.

Another challenge with a purely data-driven approach relates to lack of physical interpretability of data-driven models. In practical builds, a cross section of the part can change with build height, which in turn can influence thermal history. Moreover, the sensor signatures also can depend on other parts on the build plate. If the build plan is changed, or parts are added or removed to the build plate, the time to scan a layer changes, which can result in a change in the sensor signatures. Consequently, sensor signatures, such as infrared, can be afflicted due to variation of the part shape and build layout, as well as from flaw formation. In other words, the sensor signatures can be liable to contain both common cause variations resulting from the shape of the part, as well as special cause variation due to onset of flaws. Hence, data-driven (black box) models, while adept at capturing and isolating variations in the data, may incorrectly flag a natural (common cause) variation in the sensor data due to the changing cross section of the part as a process-induced flaw. Therefore, data-driven models that do not incorporate the fundamental thermal physics of LPBF can likely record false alarms.

Yet another challenge with purely data-driven approaches is a data-driven modeling concern with lack of prescriptive input to correct the process once a flaw has been isolated. This is because data-driven models may not suggest a means to correct an identified flaw (e.g., changing process parameters or reprocessing a layer). An alternative to purely data-driven process monitoring is the digital twin approach in additive manufacturing, as described throughout this disclosure. The digital twin approach can fuse the process phenomena predicted from a mechanistic physics-based model with in-situ process signatures for prediction of process flaw formation and microstructure evolution. A machine learning model can be used to correlate mechanistic model predictions and sensor data with flaw formation. In other words, the physics captured by the model can be combined implicitly with the in-situ sensor data via machine learning. For instance, porosity formation can be predicted in directed energy deposition processed parts by combining the part-level temperature distribution predicted from the graph theory simulation with in-process infrared thermal imaging data inside a support vector machine learning model. Such a digital twin, albeit where the sensor data and model are not explicitly coupled, can be more accurate compared to a purely data-driven model in the context of flaw detection. As described herein, instead of using a machine learning model to make correlations in the digital twin approach, real-time sensor data can be used as a direct input to a physical thermal model to more accurately and quickly detect flaw formation in parts.

Apart from accuracy, to be practically useful, thermal models can be computationally efficient when scaled to large-scale parts with complex geometry. A measure of computational efficiency can be simulation time, which may ideally be less than time required to print a part. Further for online monitoring, the model should facilitate real-time updates based on in-process data. A conventional approach for thermal modeling in LPBF, and metal additive manufacturing in general, is finite element (FE) approach. A computational bottleneck in using FE modeling in LPBF can be that the volume of the part may not be static, but can increase as layers are added. In other words, the computational domain for FE-based thermal simulation can change in LPBF (and additive manufacturing in general). Consequently, to accommodate the evolving shape of the part, two techniques can be used in FE-based thermal modeling. The first is an element birth-and-death approach, where elements can be progressively activated to simulate the deposition of materials. The second approach, called the quiet element method, can be in which the final volume of the part is meshed, but elements representing material that is the yet to be deposited are not assigned thermal properties.

To speed up computation, adaptive FE meshing techniques can be incorporated. In adaptive meshing, the element size may not be constant but can change layer-to-layer. The elements in large, bulk areas can be coarser compared to those representing finer features. Further, size of elements in preceding layers can be coarsened based on a rationale that the temperature of preceding layers reaches a steady-state temperature. Two other simplifications can be made in FE models to speed up computation, which include: (i) the meta-layer or super-layer approach where the deposition of multiple layers can be simulated, and (ii) the part-scaling approach in which only a representative section of a (symmetric) part can be simulated. As a result, there can be a tradeoff involved in computational efficiency versus accuracy on account of these simplifications.

Computation time using FE models can be excessive. For example, it can take days, if not hours, to simulate temperature distribution for a few layers. For example, an FE-based thermal model to simulate just 1 minute of LPBF processing for a dia. 2 mm×0.3 mm impeller can require 20 hours of desktop computing. Adaptive meshing and GPU computing approaches in FE modeling can be used to predict the effect of thermal history. Existing commercial thermal simulation packages for LPBF predominantly use the FE method with adaptive meshing to speed computation. Whilst these commercial packages can converge within a fraction of build time, they can result in distortion predictions obtained from thermal simulations that can vary as much as 60% to 100%. Moreover, commercial packages may not have a pathway to incorporate real-time in-situ sensor data for online monitoring and flaw detection. The disclosed techniques, therefore, provide for quick and accurate monitoring and flaw detection as parts of built using the additive manufacturing process.

### Section 3: Experiments

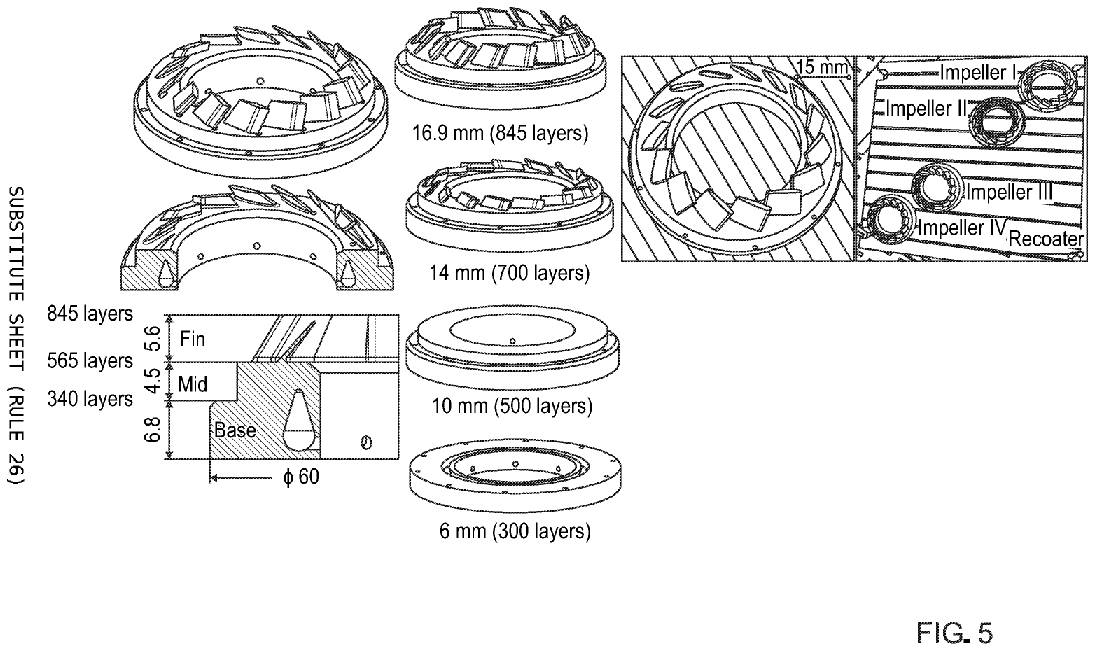

FIG. 5 depicts four example, identical stainless steel impeller-shaped parts (e.g., Impellers I, II, III, and IV) that were simultaneously built using the disclosed techniques. In particular, FIG. 5 depicts a cross section of an impeller showing three build sections: base, mid, and fin. A cooling channel located in the base and mid-section is also visible. The progressive building of impeller geometry is also shown. FIG. 5 also depicts an actual impeller shape and layout of each of the Impellers I, II, III, and IV on the build plate.

Four identical stainless steel (e . . . g, SAE 316L) impeller-shaped parts of diameter 60 mm and height 16.9 mm, as exemplified in FIG. 5, can be built simultaneously on an EOS M290 machine or other type of LPBF or additive manufacturing machine. A part can be divisible into three prominent build regions: base, mid, and fin-sections. A teardrop-shaped cooling channel can be included inside the part. The build time can be approximately 16.5 hours. FIG. 5 provides a non-limiting example build plan and parts. The disclosed techniques can also be applied to other build plans and parts.

A summary of fixed process conditions for the example build plan of FIG. 5 are presented in Table 1. As discussed previously, three types of flaws can be initiated during the build process depicted and described herein as an illustrative example.

TABLE 1
Process parameters used for processing the
four impeller-shaped parts in this work.

| Process Parameter | Values [units] | |
|---|---|---|
| Laser type and wavelength. | Nd: YAG, 1064 nm | |
| Laser power (P) | Varies per part (see Table 2) | |
| Scanning Speed (V) | 1083 | [mm · s⁻¹] |
| Hatch spacing (H) | 0.09 | [mm] |
| Layer thickness (T) | 0.02 | [mm] |
| Stripes overlap | 0.12 | [mm] |
| Stripe width | 5 | [mm] |
| Scanning strategy | | |
| Build atmosphere | Argon | |
| Build plate Preheat temperature | 110° | C. |

| Material Properties | Values [units] |
|---|---|
| Material type | SS316L |
| Particle size range | [mm] |

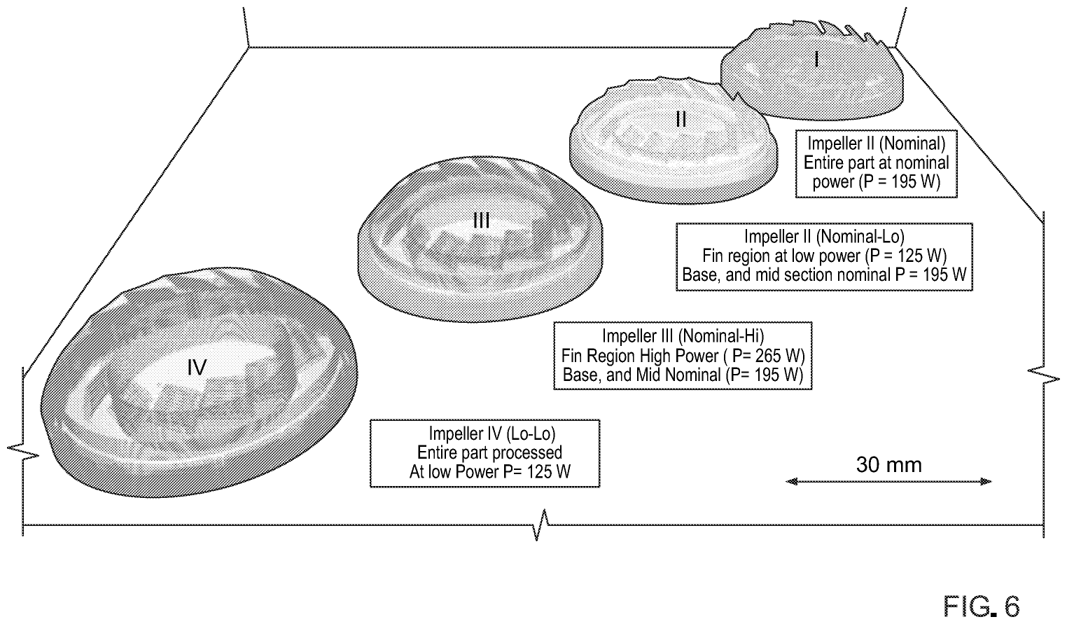

FIG. 6 depicts case 1, in which the four impellers of FIG. 5 are produced under different laser power conditions to mimic an effect of process drifts. The four impeller parts can be built in this illustrative example under differing laser power settings to mimic process anomalies or drifts.

TABLE 2
Summary of laser power utilized to create
each parts impeller build section.

| | | Base and | Fin |
|---|---|---|---|
| | Remarks | Mid section | Section |
| Impeller I | Constant Power Settings | 195 W | 195 W |
| (Nominal | | | |
| Conditions) | | | |
| Impeller II | Fin region processed | 195 W | 125 W |
| (Nominal-Lo) | with low laser power | | |
| Impeller III | Fin region processed | 195 W | 265 W |
| (Nominal-Hi) | with high laser power | | |
| Impeller IV | Entire part processed under | 125 W | 125 W |
| (Lo-Lo) | lower than nominal power | | |

The change in laser power can constitute the first type of flaw formation described herein (Case I). For example, for the part labeled Impeller I, the laser power can be fixed at 195 W throughout the build. Impeller I can be considered a flaw-free standard or baseline part produced under nominal (acceptable) conditions.

The base and mid-sections of Impeller II can be produced at the nominal laser power of 195 W, whilst the fin section can be produced under reduced laser power of 125 W. Impeller II can be termed as processed under Nominal-Lo laser powder settings. Reduction of the laser power from 195 W to 125 W can be liable to result in lack-of-fusion porosity.

Impeller III can be produced under Nominal-Hi conditions with the base and mid sections processed at laser power 195 W, with the fin section produced at 265 W. The increase in the laser power of the thin cross-section can be liable to cause excessive heating in the thin cross-section fin region, leading to grain coarsening.

Lastly, Impeller IV (Lo-Lo) can be produced at 125 W throughout and can be anticipated to depicted greater degree of lack-of-fusion flaw formation throughout its structure.

To simulate cyber-physical intrusions during the process in Impellers II, III and IV, spherical-shaped voids can be embedded into the base section of the impeller. These planted flaws can constitute the second type of flaws described herein (Case II).

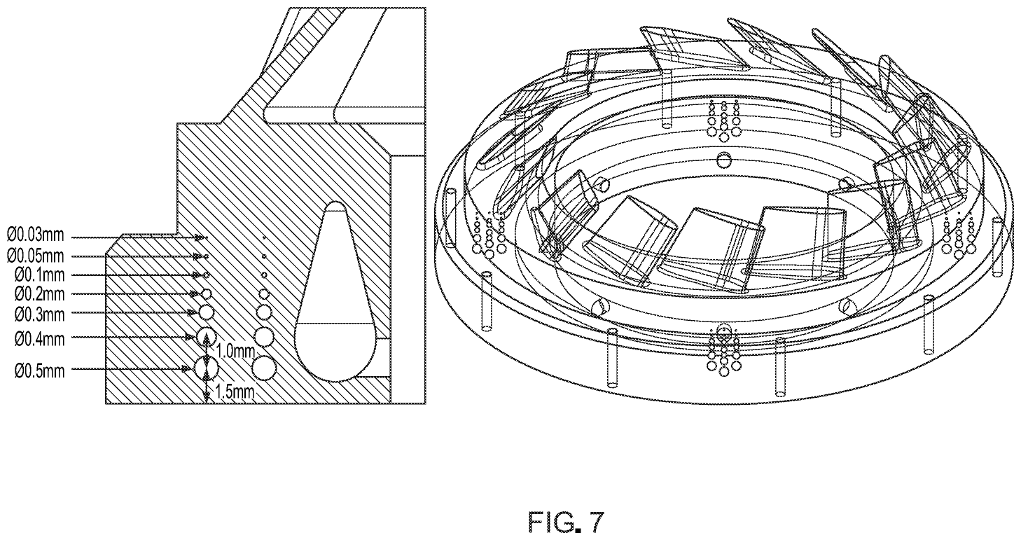

FIG. 7 illustrates artificial flaws introduce into three of the four impellers, Impellers II, III, and IV. There are a total of 13 spherical-shaped voids of diameter varying from 0.5 mm to 0.03 mm planted in each quadrant of the impellers. Accordingly, FIG. 7 details the location and relative size of the artificial defects. Fifty-two spherical voids of diameters ranging from 0.5 mm to 0.03 mm can be created in each impeller. 13 embedded voids can also appear in each quarter sector (quadrant) of the impeller, as shown. Each void can be created by switching off the laser at each location.

Lastly, the third type of flaw (Case III) described herein can concern lens delamination, which can be degradation of optical coatings on the f-θ lens and can be liable to cause disturbances in the fidelity of laser focus and variation in energy delivered for melting.

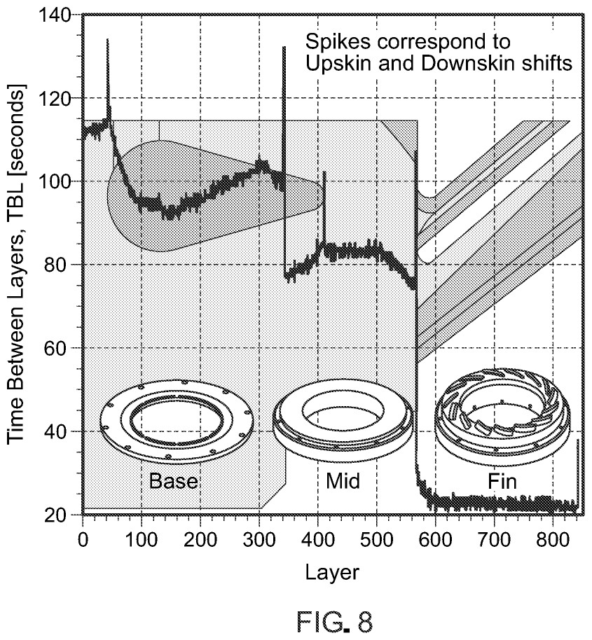

FIG. 8 is a graph depicting time between layers (e.g., inter-layer time, TBL) of the four impellers of FIG. 5. The time between layers can reduce during the build in proportion to the surface area scanned. The fin-section can have a smallest surface area, and hence the laser can require the least time (e.g., less than 5 seconds) to scan layers in the fin region. The time to recoat a layer is not depicted in FIG. 8. The recoat time can be constant at 10 seconds per layer.

A consideration in LPBF is time between layers, which is a cycle time elapsed between melting of two consecutive layers. FIG. 8 accordingly represents TBL values for Impeller I as a function of layer height. The TBL can be identical for all four impellers of FIG. 5 described throughout this disclosure. Due to variable cross section of each layer, the time between the deposited layers may not be constant, but can change layer-to-layer. TBL therefore is a function of build parameters (e.g., laser velocity, hatch spacing, scanning pattern), the surface area of a layer scanned by the laser, and the layer recoating time (e.g., a constant).

In the present disclosure, the surface area of the impeller scanned by the laser progressively can reduce as a function of the build height, which can result in a proportion reduction in the TBL with layers, as seen in FIG. 8. The TBL can be estimated assuming that there is no process stoppage, such as a recoater crash, before the build. This estimate can be made using a slicing software simultion (e.g., akin to a G-code emulator).

Three distinct phases can be observed in the TBL corresponding to the three sections of the parts: base, mid, and fin. In addition, several momentary peaks can be observed, which can be caused by upskin and downskin contour finishing parameters. Upskin surfaces refer to regions where there may be unmelted powder above a layer. Conversely, downskin layer can include those that can have unmelted powder below. Upskin and downskin regions can be processed at a reduced velocity compared to the bulk of the part to improve the surface finish.

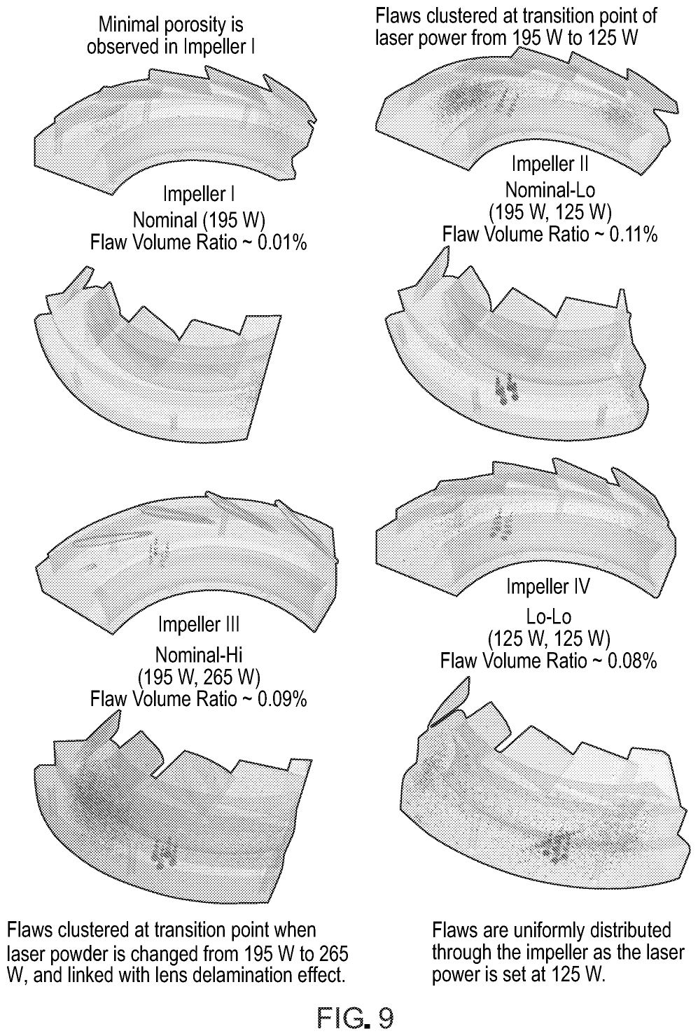

FIG. 9 depicts X-ray CT images of two quarter-sections of each of the four impellers that demonstrate a marked difference in porosity. Impeller I, produced under nominal conditions, can have few pores, compared to Impellers II, III, and IV. In Impeller II, the flaws tend to occur in the region between the mid and fin-section at the transition point when the laser power is reduced from 195 W to 125 W. In Impeller III, flaws can be clustered at the laser power transition point and likely may be interlinked with lens delamination.

Both non-destructive evaluation and destructive materials characterization methods can be used to understand and quantify flaw formation in the four impellers of FIG. 5. Each impeller can be scanned for flaw formation using non-destructive X-ray Computed tomography (XCT). The XCT analysis can allow estimation of location, distribution, and density of flaw formation (typically lack-of-fusion porosity). Subsequent to XCT, each impeller can be cross-sectioned, polished, and etched for materials characterization. The destructive characterization can include optical microscopy (large field-of-view microstructure and type of flaw), scanning electron microscopy (SEM) for texture and grain size measurement, and electron backscatter diffraction (EBSD) to evaluate size and orientation of grains.

The four impellers can be examined using XCT (e.g., NorthStar Imaging, NSI, or other similar imaging) at voxel resolution of 10 μm. Shown in FIG. 9 are the XCT section views for the four impellers. The corresponding flaw characteristics, including flaw volume as a percentage of the total volume are reported in Table 3.

TABLE 3
The flaw characteristics for each of the four
impellers, including the flaw volume ratio.

| | Flaw Volume | Total Part | Flaw Volume |
|---|---|---|---|
| Impeller | [mm³] | Volume [mm³] | Ratio [%] |
| Impeller I | 1.29 | 18497 | ~0.01 |
| (Nominal Conditions) | | | |
| Impeller II | 19.10 | | ~0.11 |
| (Nominal-Lo) | | | |
| Impeller III | 15.23 | | ~0.09 |
| (Nominal-Hi) | | | |
| Impeller IV (Lo-Lo) | 13.29 | | ~0.08 |

Impeller I, which can be processed under nominal, fixed conditions of 196 W, had the least percentage flaw volume (0.01%). For the rest of the parts, the percentage flaw volume ranges from 0.08% to 0.11%. The flaws in Impeller II can be predominantly clustered in the vicinity of the fin region, corresponding to the transition in the laser power from 195 W to 125 W. A similar clustering of flaws at the transition point can be observed in Impeller III. The clustering of flaws in Impeller III can be explained as a combination of the effect of lens delamination in addition to the effect of change in laser power. In contrast, for Impeller IV, the flaws can be evenly distributed, as the entire part can be produced at low-level of laser power of 125 W.

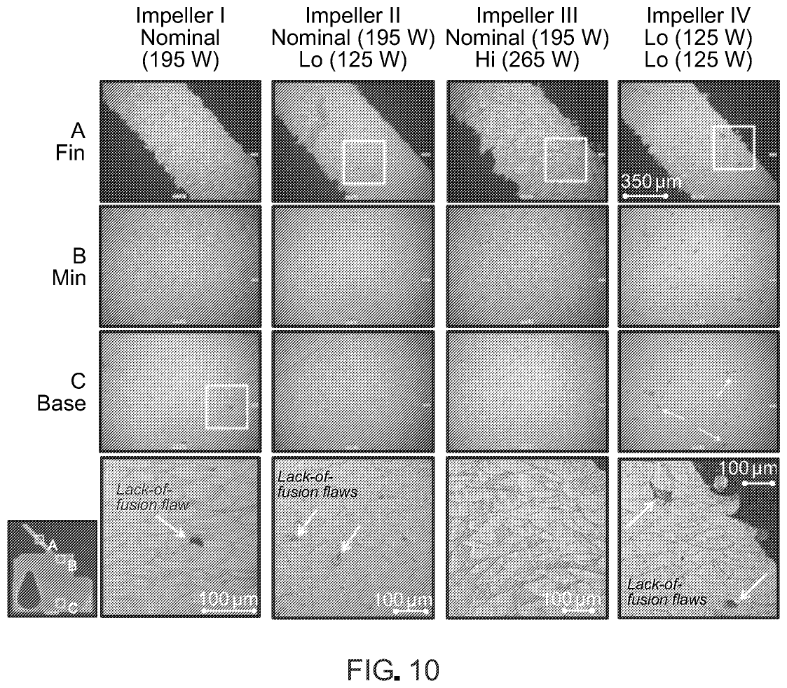

FIG. 10 depicts an effect of change in processing conditions on microstructure and porosity of the impellers. To understand the nature (type) of flaw formation and microstructure evolved, the four impellers of FIG. 5 can be cross-sectioned, polished, and etched. Optical micrographs for the four impellers are shown in FIG. 10, corresponding to (A) fin, (B) mid, and (C) base sections. The bottom-most row of images are zoomed-in views of the demarcated regions for each impeller. There are large number of pores in the fin-section for Impeller II, which can be produced under the Nominal-Lo condition (195 W-125 W). The fin-region of Impeller III, produced under Nominal-Hi (195 W-265 W), conditions can have coarser microstructure compared to others. Impeller IV, which can be produced under low power settings of 125 W, can show presence of lack-of-fusion porosity along its entire cross-section.

As mentioned above, three regions of each impeller depicted in FIG. 10 include base (A), mid (B), and fin (C). Affirming the XCT analysis, Impeller I produced under nominal conditions did not depict extensive flaw formation. Lack-of-fusion type of flaw formation can be observed in Impellers II and IV. These flaws can be of the lack-of-fusion type from their irregular shape. The lack-of-fusion flaws can be observed to range between 30 μm to 50 μm in width. The reduction in laser power in the fin section can likely cause these flaws on account of poor consolidation. Impeller III, which can be produced under Nominal-Hi conditions, can have a distinctively different microstructure (e.g., texture and grain size) compared to the other impellers. Particularly, the grain size in the fin region of Impeller III can be significantly coarser relative to other parts, which can suggest grain coarsening on account of heat accumulation and reduced cooling rate.

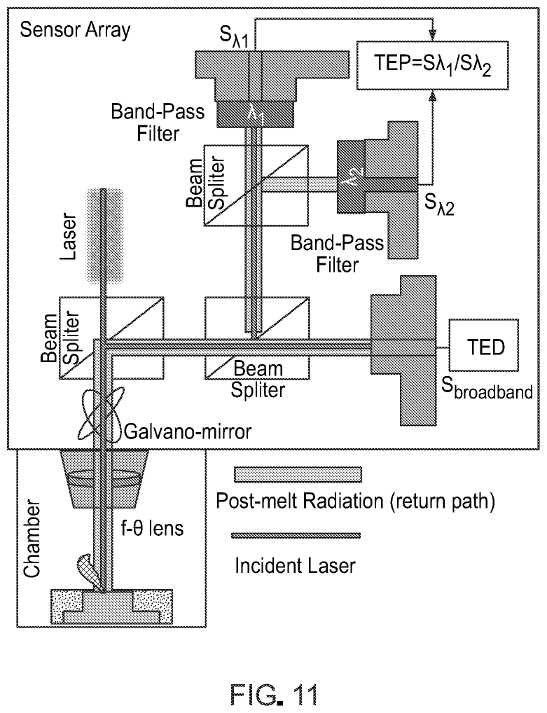

FIG. 11 is a schematic diagram of an example LPBF machine and an on-axis sensing setup that can be used with the disclosed techniques. In some implementations, two bandpass filtered photodetectors can be used to obtain the signature termed TEP and one photodetector can be used to measure process energy input. One or more other configurations of photodetectors and sensors can be used to perform the disclosed techniques.

During LPBF, a part can be progressively buried inside powder, which can make it impracticable to measure temperature inside the part. It may be possible to measure the temperature on the surface, and, to some extent, temperature at discrete points at the bottom of the part by embedding thermocouples within the build plate or inside the part. However, the thermocouples may provide limited point measurements of the temperature, and the signals can be progressively attenuated as the part grows in size.

A schematic of on-axis sensing system integrated into an EOS M290 system or similar additive manufacturing system is provided in FIG. 11. Such a system can capture spectral emissions from a meltpool region using an sensing array consisting of at least three photodetectors that can be coaxial with the laser path. Two types of process signatures can be derived from the photodetector data. The first metric, termed Thermal Energy Planck (TEP), is a ratio of signal intensities of two photodetectors equipped with band-pass filters close to an infrared spectrum (21=700 nm and 22=900 nm). The second metric, termed Thermal Energy Density (TED), can represent data acquired by a third photodetector that may not have an optical band pass filter, and hence can capture optical emissions in the optical spectrum ranging from 300 nm to 1200 nm.

To explain further, the TEP metric can capture spectral emissions from the meltpool region within specific wavelengths determined by optical bandpass filters incorporated into the photodetector. These bandpass frequencies can be chosen to match with peak spectral radiance obtained from Planck's law. The TED metric can be used to detect broadband energy emissions from the meltpool region.

The sensing system can be triggered at a start of a layer, and each sample measurement can be correlated to a build location based on a laser Galvano-mirror feedback. The location where the meltpool senor data is acquired can be registered to a position of the laser. Hence, it can be possible to track the process from the meltpool level to the hatch-by-hatch and layer-by-layer level.

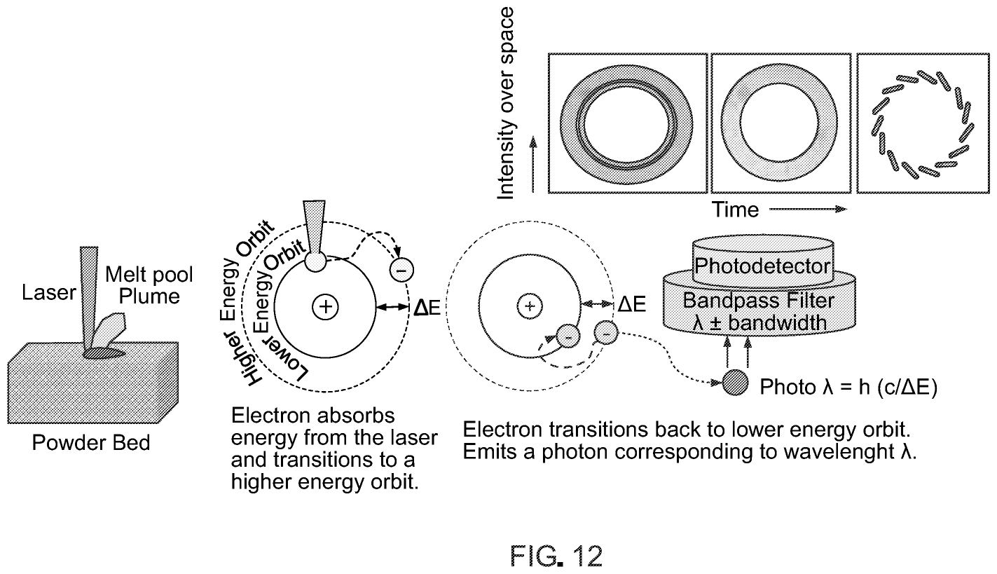

FIG. 12 is a conceptual diagram for measuring emissions from a meltpool region of an impeller using a bandpass filtered photodetector. A key difference in the TEP and TED signatures can result from using optical filters. The TEP signatures can be akin to optical emission spectroscopy measurements since they can capture radiation in specific regions. As a material is heated by the laser, its electrons can transition to a higher energy state and on returning to the previous energy state, the electron can emit a photon. The wavelength of the photon (λ) released can be in accordance with the Planck-Einstein relationship E=hcλ⁻¹. The photodetectors from which the TEP signature is obtained can be bandpass filtered to detect these emissions resulting from material fusion.

The TEP can capture a ratio of signal intensity from each of the photodetectors, TEP=log ₁₀ (S_{λ1}/S_{λ2}). The temperature of a body can be proportional to radiated intensity, so the TEP measurement can be proportional to the temperature of the meltpool region, with material emissivity as a proportionality constant. However, material emissivity may not be a constant, but instead can depend on surface roughness, inclination of the body to the sensor, and temperature of the body. Hence, using the ratio of the intensities in the TEP signatures at two different wavelengths can have an effect of canceling the effect of material emissivity.

The third photodetector, from which the TED signature can be obtained may not filter the optical emissions and can capture the broadband radiation from the return path of the laser. The sensor array may not provide an absolute temperature reading and may be calibrated as described further below. In brief, the TEP signatures can be normalized in a range of 1800° C. to 2200° C. in keeping with the temperature ranges observed in the LPBF of stainless steel 316L.

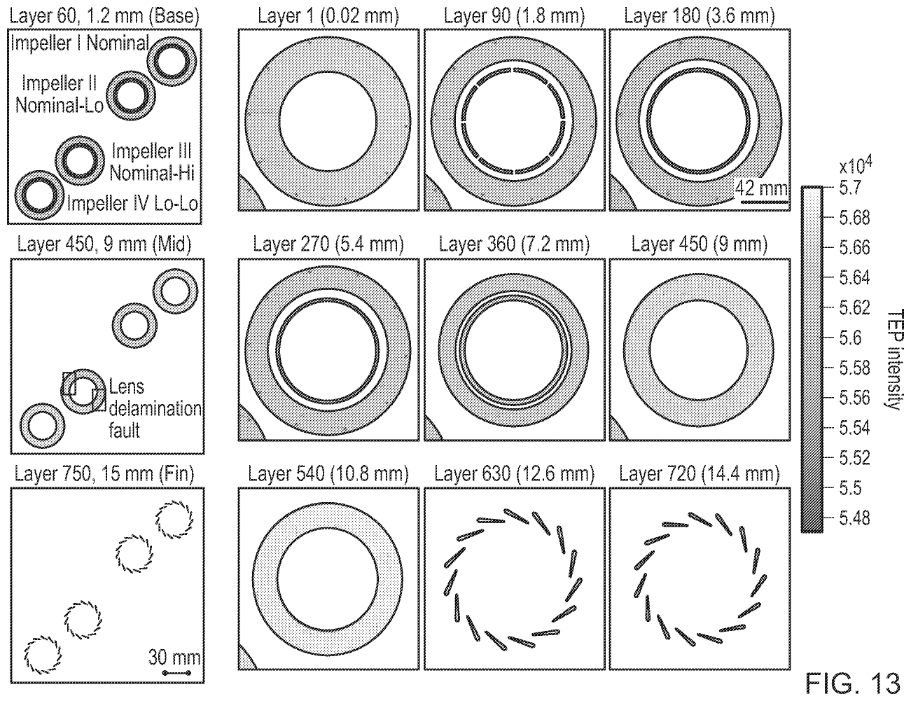

FIG. 13 depicts example Thermal Energy Planck (TEP) sensor measurements consolidated in a 2D color-scaled image for all four impellers of FIG. 5. The resolution of the data is 125 μm×125 μm per pixel. In particular, TEP measurements are compiled for various layers for all four impellers along with TEP measurements for Impeller I. Process faults can be due to lens delamination, which can be observed in Impeller III in the demarcated regions. Due to delamination, the intensity of TEP signatures can be markedly reduced. The images of FIG. 13 are sampled immediately following the melting of the layer. To obtain a temporal (1D) trend of sensor data as a function of time, the TEP and TED signatures can be sampled for specific spatial regions of the part. The measurements at these regions can be combined and used as inputs to the graph theory approach, as described in Phase I of the digital twin approach. In practice, several hundred such critical regions of the part can be sampled and monitored in parallel, without sacrificing computational efficiency, as the thermal history can be simulated for the entire part.

The TEP and TED measurements can be acquired continuously throughout the build at a sampling rate of 200 KHZ and 100 kHz, respectively. These measurements can be registered to a location of the laser based on feedback from a position of the Galvano-mirror of the laser. Accordingly, a large volume of multi-sensor data can be acquired at high velocity (sampling rate).

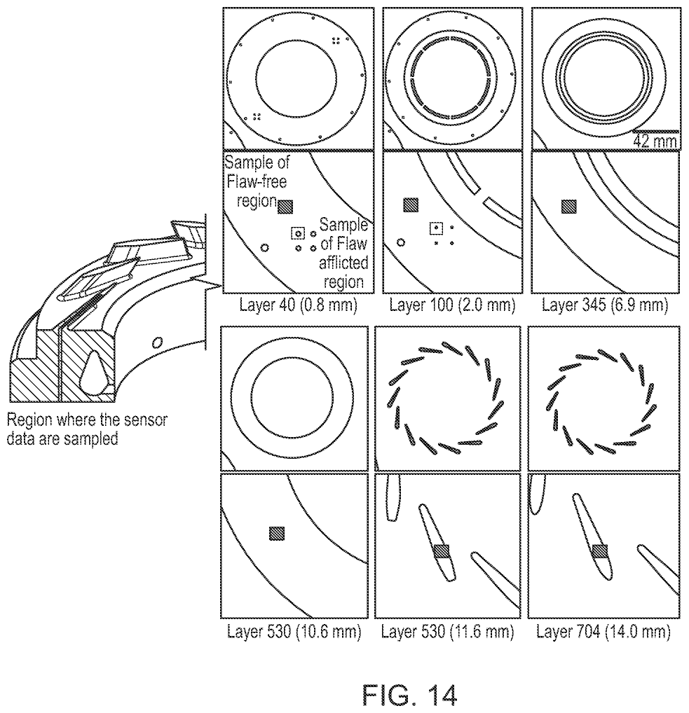

FIG. 14 depicts spatial regions where sensor data can be acquired in the impellers of FIG. 5. The sampled area can be 2 pixels×2 pixels (250 μm×250 μm). TEP/TED sampled area for defected (red) and non-defected (black) regions are depicted in FIG. 14. Because there are no implanted flaws above the mid section, the same area can be used for both data samples.

Temperature data over three types of locations can be sampled: (i) locations without any artificially planted flaws, (ii) locations where flaws were planted, and (iii) regions where lens delamination was suspected. The sample area equates to a total of 4 pixels in terms of the sensor data on surface of the current layer being deposited on the part. The sample area can be selected so as to contain a narrow cross-section of the fin. Sampling near the boundaries can be avoided to reduce blurring and resolution-related errors. In the base and mid sections of the impeller, the sample area can be held in the same location for each layer. The sample area for the fin can be relocated with each layer to accommodate the changing section of the fin.

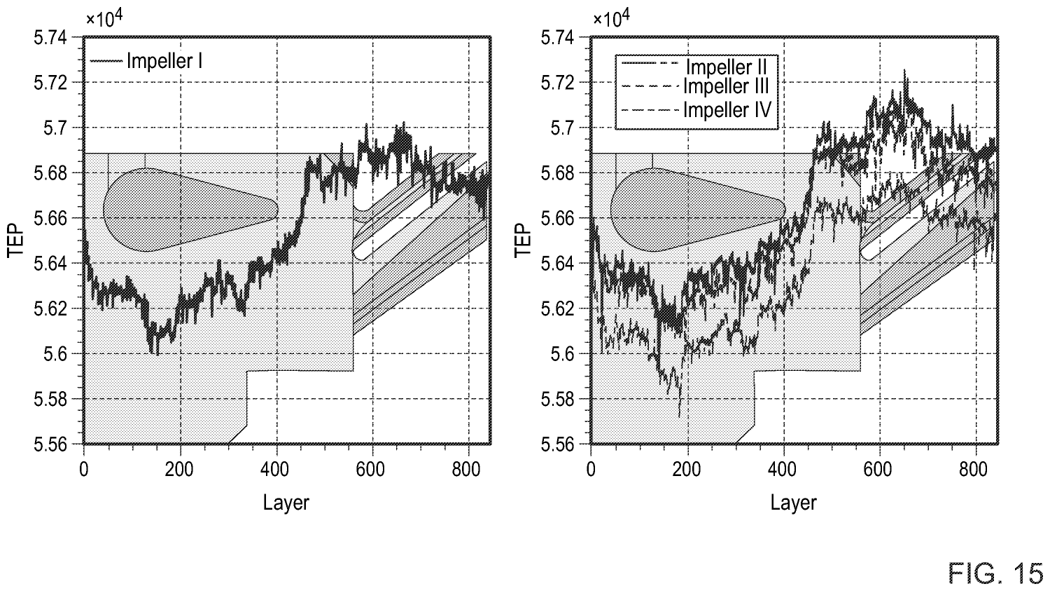

FIG. 15 includes graphical depictions of TEP signatures for Impeller I and TEP data for Impellers II, III, and IV. Except Impeller I, which is consistently produced at low power of 125 W for all sections, there may be little noticeable difference in the TEP measurements for the impellers. Moreover, the TEP measurements can increase with the build height, and can reach a peak value for all sensors in the region of the fin due to its reduced cross section.

In other words, TEP measurements can be sampled at locations without planted flaws for the four impellers, as a function of layer height. As evident from FIG. 15, all impellers exhibited similar TEP responses, indicating the consequential effect of geometry (shape) of the part in determining the thermal history. In FIG. 15 (right), the TEP measurements for Impeller IV can be reduced in comparison to Impeller II and III as it is produced at the lowest power of 125 W. However, in FIG. 15 (right), the TEP measurements may not significantly differ for Impeller II and III despite the change in laser powers in the fin-region-recalling that in the fin region, the laser power for Impeller II can be decreased from 195 W to 125 W, and the laser power for Impeller III can be increased from 195 W to 265 W. Moreover, the TEP signature for Impeller II may not reduce in the fin region to the same level as Impeller IV even though the laser power is reduced to 125 W.

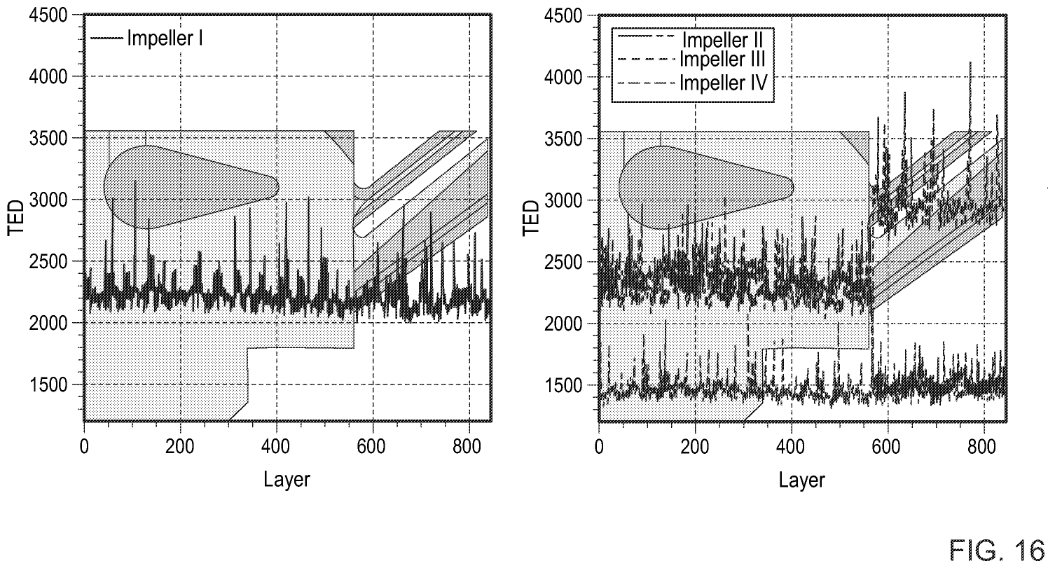

FIG. 16 includes graphical depictions of Thermal Energy Density (TED) photodetector responses for each of the impellers. TED can capture deviations from the nominal laser power of 195 W. Laser power reductions and increases in the fin can be captured in Impellers II and III. In other words, the TED measurements sampled at locations without planted flaws is shown in FIG. 16. Unlike TEP measurements, the TED measurements can vary prominently between regions produced under differing laser power condition. This is because the TED measurements can be obtained from broadband chamber emissions. However, the TED measurements may not capture variation in temperature distribution resulting from the part geometry. In other words, the TEP and TED data can be complementary, the former (TEP) can be sensitive to the effect of part shape on the thermal history and the latter (TED) can capture variation between parts resulting from change in processing parameters.

Both FIGS. 15 and 16 refer to case I, which is effect of change in process parameters.

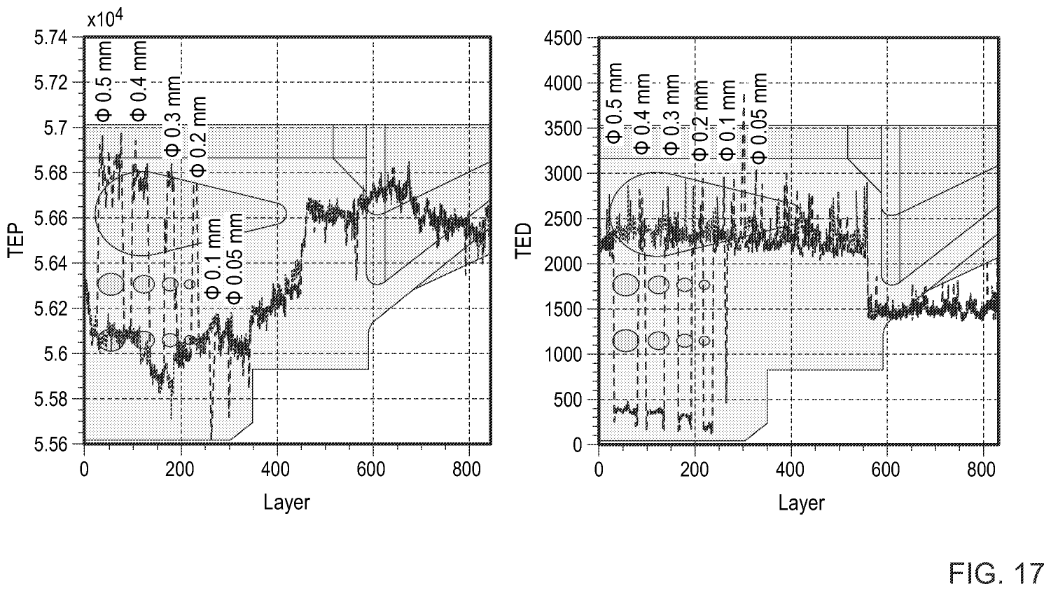

FIG. 17 includes graphical depictions of effects of planted flaws on TEP and TED measurements relative to trends for a flaw free region of an impeller. Spikes in the TEP and TED can correspond to presence of flaws. Flaws as large as 0.050 mm (50 μm) can be discerned from the signal characteristics, as shown in FIG. 17.

More particularly, FIG. 17(a) and FIG. 17(b) show the TEP and TED signatures averaged over a layer, respectively, at locations where flaws can be deliberately planted. In both measurements, large deviations (spikes) can be observed at locations with embedded flaws due to partially fused and unmelted powder trapped inside the voids. Six such spikes can be evident in FIG. 17, corresponding to the six largest diameter flaws-Φ0.5 mm, Φ0.4 mm, Φ 0.3 mm, Φ 0.2 mm, Φ0.1 mm, and Φ 0.05 mm. The smallest planted flaws of Φ 0.03 mm may not readily be discerned in the sensor measurements. FIG. 17 refers to case II, which is the effect of planted flaws.

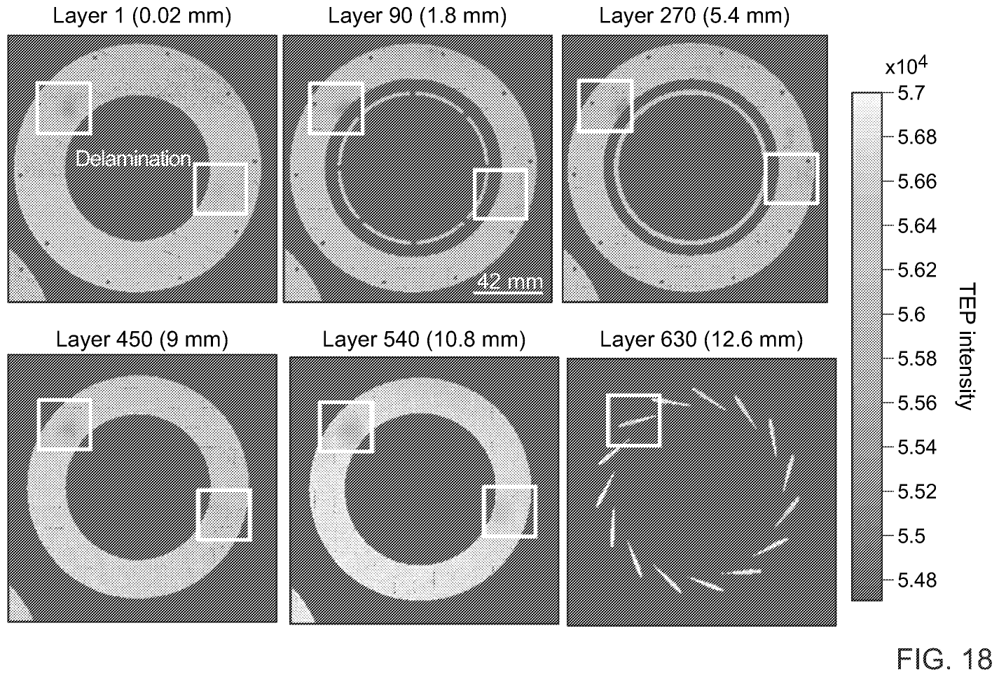

FIG. 18 is a representative 2D TEP measurements for six layers of Impeller III. In the demarcated locations, these TEP measurements show presence of regions affected by lens delamination. Note the areas of persistent low intensity in the northwest quadrant. The effect of lens delamination can be evident in the low intensity of the TEP signature in FIG. 18(a). These regions can appear consistently over multiple layers of the base and mid-section until only a small area persists in the fin region.

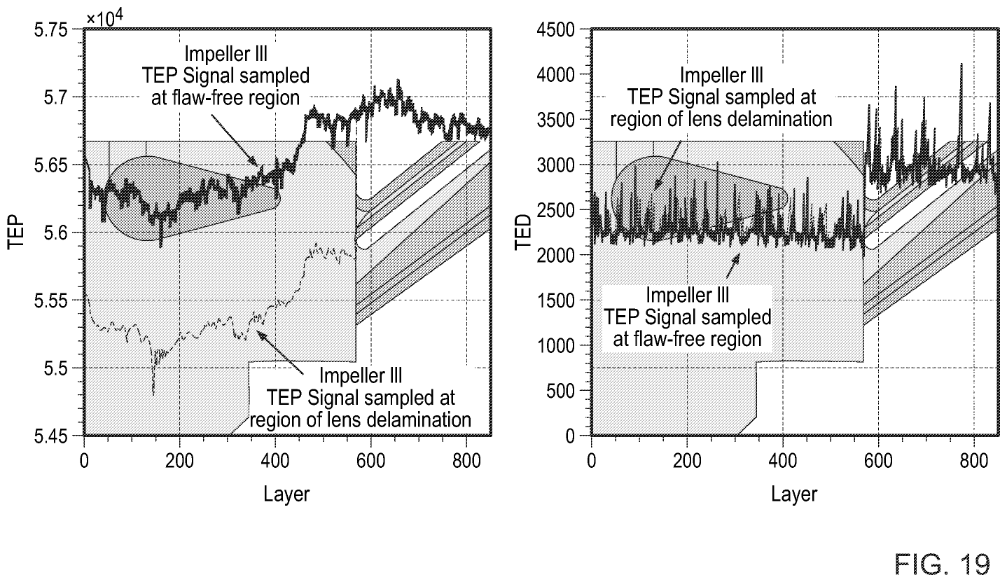

FIG. 19 includes graphical depictions comparing TEP and TED measurements sampled at flaw-free regions and at regions with lens delamination. The flaw-free regions can be depicted in the graphical depictions as solid lines. The regions with lens delamination can be depicted as dotted lines. As shown in FIG. 19(a), there can be a significant difference in TEP trends prior to melting of the fin region. As shown in FIG. 19(b), the TED signatures for flaw-free and delamination-afflicted regions may be visually indistinguishable.

The TEP and TED trends are plotted over a Y pixel x Y pixel region in FIG. 19(a) and FIG. 19(b), respectively. The reduced intensity of the TEP signature for the delamination region can be evident on comparison to the TEP signatures for the flaw-free region of Impeller III in FIG. 19(a). This difference can persist until the fin region. The increased laser power during the processing of the fin region of Impeller III, coupled with its smaller surface area, can reduce deleterious impact of lens delamination. In contrast to the TEP signatures, the TED signature may not register discernable differences when sampled between the regions with and without lens delamination.

Both FIGS. 18 and 19 refer to case III, which is the effect of lens delamination. Moreover, FIGS. 16-18 reveal effectiveness and complementary nature of the TEP and TED measurements in capturing potential flaws resulting from both process drifts and planted flaws. However, the following limitations and challenges impede the direct use of sensor measurements for flaw monitoring. First, the TEP and TED data can be acquired at a sampling rate of 200 kHZ and 100 kHZ, respectively, and continuously throughout the 16.5 hour build time. In total, data amounting to 3 gigabytes of two types of processing signatures (TEP and TED) can be stored. It may therefore be infeasible to detect flaw formation in real-time through visual analysis of the signal due to the long time of data acquisition and large amount of data that is collected, stored, and processed during the build time. Second, the TEP and TED process signatures can contain information from both common cause variations resulting from the part shape, as well as special cause variations from change in laser power, embedded voids, and lens delamination. In the absence of a physics-based model to delineate these thermal trends, it can be difficult to separate the common variation from the special-cause variation contained in the signal, which can lead to large detection errors.

### Section 4: The Graph Theory Approach for Thermal Modeling

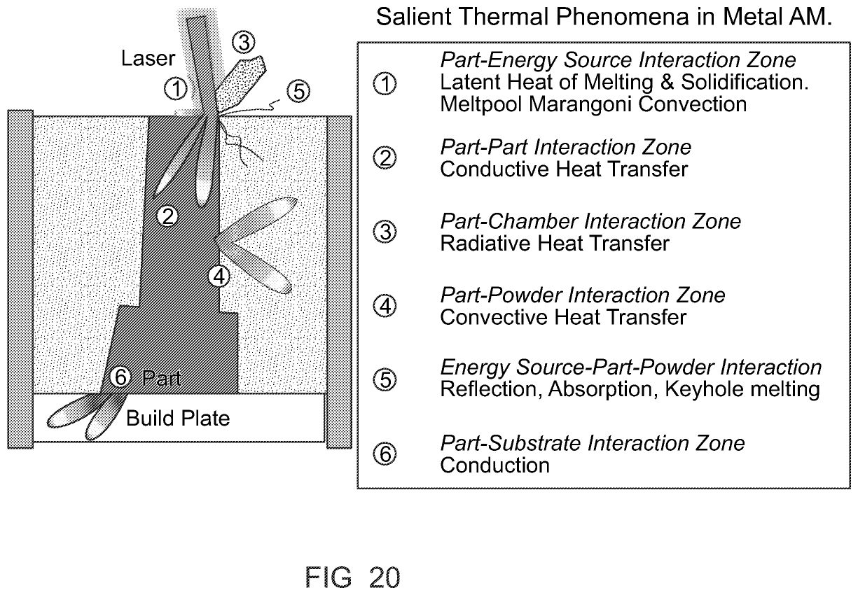

FIG. 20 is a conceptual diagram depicting thermal phenomena in LPBF extended past multiple scales. As a part is buried inside powder during the LPBF process, it may not be practically feasible to measure temperature inside the part. Therefore, to map the temperature distribution (e.g., thermal history) of an LPBF part, it can be necessary to resort to ab-initio thermal modeling.

Thermal aspects of the LPBF process are depicted in FIG. 20. They encompass conductive, convective, and radiative heat transfer phenomena across three scales, namely, meltpool scale (<100 μm), meso-scale track-level (100 μm⁻¹ mm), and part-scale (>1 mm). It can be computationally cumbersome to capture phenomena from all three scales within a single model. Particularly, meltpool modeling in LPBF can be time consuming and can require high performance computing. The graph theory approach, therefore, has at least two advantages over FE-based approaches.

First, the graph theory approach can eliminate mesh-based analysis. The graph theory approach can represent the part as discrete nodes, which can help eliminate tedious meshing and re-meshing steps that may be required in the element birth-and-death approach used in FE-based analysis of LPBF. Second, the graph theory approach can eliminate matrix inversion steps. While FE analysis can rest on matrix inversion at each timestep for solving the heat diffusion equation, the graph theory approach can use matrix multiplication, which can reduce the computational burden.

To predict thermal history the heat diffusion equation can be solved.

$${\overbrace{ρ {c}_{p}}}^{\begin{matrix}Material \\ Properties\end{matrix}} \frac{\partial T ( x , y , z , t )}{\partial t} − k {\overbrace{( \frac{{\partial }^{2}}{\partial {x}^{2}} + \frac{{\partial }^{2}}{\partial {y}^{2}} + \frac{{\partial }^{2}}{\partial {z}^{2}} )}}^{Shape of the Part} T ( x , y , z , t ) = {\overbrace{\frac{P}{v \times h \times d} = {E}_{V}}}^{Parameters} \qquad ( 1 )$$

Here T can be a temperature rise above an ambient temperature. The accompanying initial and boundary conditions can be given by,

$$T ( x , y , z , 0 ) = 0 ( initial condition ) \qquad ( 2 )$$

$$\frac{\partial T}{\partial n} = 0 ( on boundary )$$

Solving the heat diffusion equation can result in the temperature T(x, y, z, t) at a location (x, y, z) and time instant t inside the part. The energy density [J·m⁻³], Eᵥ, can be the energy needed to melt a unit volume of material and can be a function of laser power (P[W]), distance between tracks of the laser (h)[m], translation velocity (v) [m·s⁻¹], and layer thickness (d) [m]; these can be controllable parameters of the LPBF. The material properties can be density ρ[kg·m⁻³], specific heat cₚ [J·kg⁻¹. K⁻¹)], and thermal conductivity k[W·m⁻¹·K⁻¹]. The part shape can be represented in the second derivative term, called the continuous Laplacian.

FE analysis can be used to solve the heat diffusion equation and obtain the temperature of each node in the part [24-27, 45, 46]. Meshing of the part geometry can be the computationally time-consuming aspect of FE-based thermal analysis in LPBF. This is because the part shape can change continually with deposition of each new hatch or layer and may have to be re-meshed.

The graph theory approach, on the other hand, can reduce computational burden by solving a discrete version of the heat diffusion equation. As in existing FE approaches, the energy density E₌ᵥ in Eqn. (1) can be replaced by an initial temperature T(x, y, z, t=0)=Tₒ; where Tₒ can be the melting point of the material.

$$\frac{\partial T ( x , y , z , t )}{\partial t} - α ( \frac{{\partial }^{2}}{\partial {x}^{2}} + \frac{{\partial }^{2}}{\partial {y}^{2}} + \frac{{\partial }^{2}}{\partial {z}^{2}} ) T ( x , y , z , t ) = 0 ; a = \frac{k}{ρ {c}_{p}} \qquad ( 2 B )$$

Next, the heat diffusion equation can be discretized over M nodes by substituting the second order derivative in Eqn, (2B) (e.g., the continuous Laplacian with the discrete Laplacian Matrix (L)).

$$\frac{\partial T ( x , y , z , t )}{\partial t} + α ( L ) T ( x , y , z , t ) = 0 \qquad ( 3 )$$

The eigenvectors (ϕ) and eigenvalues (Λ) of the Laplacian matrix (L) can be found by solving the eigenvalue equation Lϕ=ϕΛ. The eigenvalues (Λ) can be non-negative, and the eigenvectors (ϕ) can be orthogonal [50-53]. Further, the transpose of an orthogonal matrix can be the same as its inverse, hence, ϕ⁻¹=ϕ′, and therefore, ϕϕ′=1. As a result, the eigenvalue equation Lϕ=ϕΛ may be post-multiplied by ϕ′ to obtain L=ϕΛϕ′. Using this relationship in Eqn. (3),

$$\frac{\partial T ( x , y , z , t )}{\partial t} + α ( {ϕΛϕ}^{′} ) T ( x , y , z , t ) = 0 ; \qquad ( 4 )$$

Eqn. (4) can be a first order, ordinary linear differential equation, which can be solved as,

$$T ( x , y , z , t ) = {e}^{- α ( {ϕΛϕ}^{′} ) t} {T}_{o} \qquad ( 5 )$$

The term e^{-α(ϕΛϕ′)t} can be simplified via a Taylor series expansion and substituting ϕϕ′=1,

$$\begin{matrix}{e}^{− α ( ϕ Λ {ϕ}^{′} ) t} & = I − \frac{ϕ Λ α t {ϕ}^{′}}{1 !} + \frac{{( ϕ Λ α t {ϕ}^{′} )}^{2}}{2 !} − \frac{{( ϕ Λ α t {ϕ}^{′} )}^{3}}{3 !} + ⋯ \\ & = I − \frac{ϕ Λ α t {ϕ}^{′}}{1 !} + \frac{( ϕ Λ α t {ϕ}^{′} ) ( ϕ Λ α t {ϕ}^{′} )}{2 !} − \frac{( ϕ Λ α t {ϕ}^{′} ) ( ϕ Λ α t {ϕ}^{′} ) ( ϕ Λ α t {ϕ}^{′} )}{3 !} + ⋯ \\ & = I − \frac{ϕ Λ α t {ϕ}^{′}}{1 !} + \frac{{{ϕ}^{′} ( Λ α t )}^{2} {ϕ}^{′}}{2 !} − \frac{{ϕ ( Λ α t )}^{3} {ϕ}^{′}}{3 !} + ⋯\end{matrix} \qquad ( 6 )$$

$${e}^{− α ( ϕ Λ {ϕ}^{′} ) t} = ϕ {e}^{− α ( Λ ) t} {ϕ}^{′}$$

Substituting, e^{-α(ϕΛϕ′)t}=ϕe^{-αΛt}ϕ′ into Eqn. (4) can give,

$${\overbrace{T ( x , y , z , t )}}^{Thermal History} = {\overbrace{ϕ {e}^{- α Λ τ} {ϕ}^{′}}}^{Part Shape} {\times \overbrace{{T}_{o}}}^{Input Temperature} \qquad ( 7 )$$

Eqn. (7) can entail that the heat diffusion equation can be solved as a function of the eigenvalues (Λ) and eigenvectors (ϕ) of the Laplacian Matrix (L), constructed on a discrete set of nodes. Also, from Eqn. (7), the thermal history can be surmised to be a function of two aspects, the shape of the part represented by ϕe^{-Λτ}′ and the input temperature or impulse function Tₒ.

Next, heat loss due to radiation and convection at the top boundary of the part can be included. For this purpose, nodes at the top boundary can be demarcated and the temperature of the boundary nodes (T_{b}) can be adjusted using lumped capacitive theory:

$${T}_{b} = {e}^{- \tilde{h} ( Δ t )} ( {T}_{b i} - {T}_{∞} ) + {T}_{∞} \qquad ( 8 )$$

Where, T_{∞}(=300 K) can be the temperature of the surroundings, T_{bi} can be the initial temperature of the boundary nodes, T_{b} can be the temperature of the boundary nodes after heat loss occurs, Δt can be the dimensionless time between laser scans, and \tilde{h} can be the normalized combined coefficient of radiation (via Stefan-Boltzmann law) and convection (via Newton's law of cooling) from boundary to the surroundings.

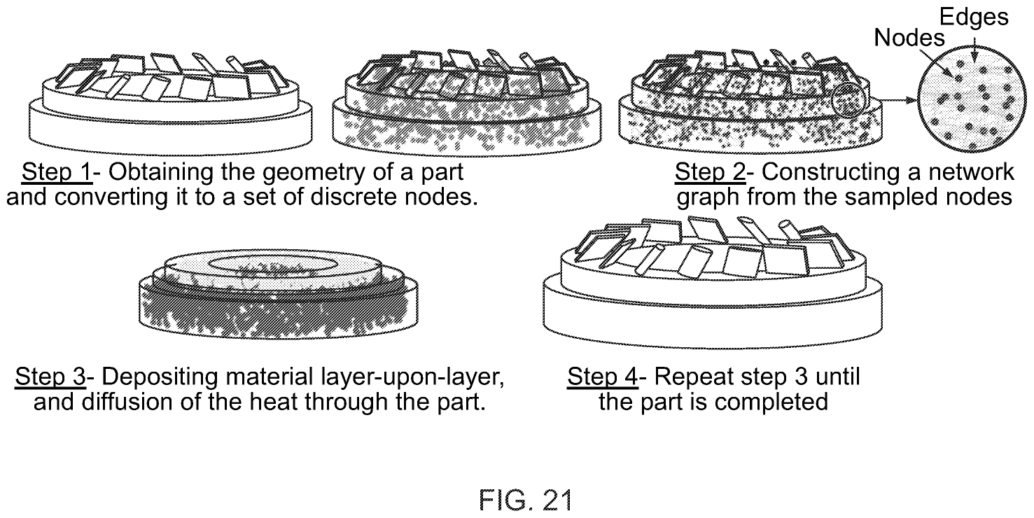

FIG. 21 is a schematic diagram depicting four steps in the graph theory approach used in the disclosed techniques. Step 1 can include converting the entire part into a set of discrete number of nodes (n) that can be randomly allocated through the part. The part can be sliced into layers and a fixed number of n spatial locations (e.g., nodes) can be sampled at random locations in each layer. The position of these nodes can be recorded in terms of their spatial coordinates (x, y, z). In the ensuing steps, the temperature at each time step can be stored at these nodes. The random sampling of the nodes can bypass expensive and otherwise timely meshing of FE analysis and can be one of the reasons for the reduced computational burden of the graph theory approach.

Step 2 can include constructing a network graph among randomly sampled nodes. As an illustrative example, consider two nodes, πᵢ and πⱼ whose spatial Cartesian coordinates can be cᵢ=(xᵢ, yᵢ, zᵢ) and cⱼ=(xⱼ, yⱼ, zⱼ), respectively; πᵢ and πⱼ can be connected by an edge whose weight a_{i,j} is given by,

$${a}_{i , j} = {e}^{− \frac{{( {c}_{i} − {c}_{j} )}^{2}}{{σ}^{2}}} . \qquad ( 9 )$$

The edge weight, aᵢⱼ can represent the normalized strength of the connection between the nodes πᵢ and πⱼ and can have a value between 0 and 1; σ² can be the variation of the distance between all nodes that are connected to each other.

A node can be connected to a certain number of its nearest neighboring nodes. First, all nodes within a certain Euclidean radius of l called the characteristic length can be connected. The characteristic length can depend upon the thinnest cross-section of the part. In some implementations, the thinnest cross-section can correspond to the fin section of 2 mm. Next, within the neighborhood of l, edges between the nearest ten nodes (η=10) can be retained. The number of nearest neighbors (η) can be calibrated. From a physical perspective, the edge weight aᵢⱼ can embody the Gaussian law (e.g., heat kernel). The closer a node πᵢ may be to another πⱼ, exponentially stronger can be the connection (aᵢⱼ) and hence proportionally greater can be the heat transfer between them.

The matrix, formed by placing aᵢⱼ in a row i and column j, can be called the adjacency matrix, A=[aᵢⱼ], where N can be the total number of nodes.

$$A = [ \begin{matrix}0 & {a}_{1 , 2} & {a}_{1 , 3} & … & {a}_{1 , N} \\ {a}_{2 , 1} & 0 & {a}_{2 , 3} & … & {a}_{2 , N} \\ {a}_{3 , 1} & {a}_{3 , 2} & 0 & … & {a}_{3 , N} \\ ⋮ & ⋮ & ⋮ & ⋱ & ⋮ \\ {a}_{N , 1} & {a}_{N , 2} & {a}_{N , 3} & … & 0\end{matrix} ] \qquad ( 10 )$$

From the adjacency matrix (A), the discrete graph Laplacian matrix L can be obtained using the following elementary matrix operations. The degree of node πᵢ can be computed by summing the i^{th} row of the adjacency matrix A.

$${d}_{i} = {\sum }_{∀ j} {a}_{i , j} \qquad ( 11 )$$

The diagonal degree matrix D can be formed from dᵢ's as follows; where n can be the number of nodes,

$$D = [ \begin{matrix}{d}_{1} & … & 0 \\ ⋮ & ⋱ & ⋮ \\ 0 & … & {d}_{n}\end{matrix} ] \qquad ( 12 )$$

From the degree of node dᵢ, the Laplacian lᵢⱼ at node i can be defined as follows:

$${l}_{i , j} {=}^{def} {d}_{i} - {a}_{i , j} \qquad ( 13 )$$

the discrete Laplacian L can be cast in matrix form as,

$$L {=}^{def} ( D - A ) . \qquad ( 14 )$$

$$L = [ \begin{matrix}+ {d}_{1} . & - {a}_{1 , 2} & - {a}_{1 , 3} & … & - {a}_{1 , N} \\ - {a}_{2 , 1} & + {d}_{2} . & - {a}_{2 , 3} & … & - {a}_{2 , N} \\ - {a}_{3 , 1} & - {a}_{3 , 2} & + {d}_{3} . & … & - {a}_{3 , N} \\ ⋮ & ⋮ & ⋮ & ⋱ & ⋮ \\ - {a}_{N , 1} & - {a}_{N , 2} & - {a}_{N , 3} & … & + {d}_{N} .\end{matrix} ]$$

Finally, the Eigen spectra of the Laplacian L, can be:

$$L ϕ = ϕ Λ . \qquad ( 15 )$$

Step 3 can include simulating deposition of the entire layer and diffusing the heat throughout the network. To aid computation, the simulation can proceed in the form of a superlayer (metalayer). In the illustrative example described throughout this disclosure, 10 actual layers can be used, each of height 50 μm for one superlayer. The thickness of each superlayer can be therefore 0.5 mm.

The heat can diffuse to the rest of the part below the current layer through the connections between the nodes. If the temperature at each node is arranged in matrix form, the steady state temperature T after time t (where t=interlayer cooling time) can be obtained as a function of the eigenvectors (ϕ) and eigenvalues (Λ) of the Laplacian matrix (L) of the network graph, viz., Eqn. (7), repeated herewith, with a tunable parameter called the gain factor (g).

$$T ( x , y , z , t ) = ϕ {e}^{- α g Λ t} {ϕ}^{′} {T}_{0} . \qquad ( 16 )$$

On the RHS, the term t on the exponent can be the time between layers or inter-layer time. The time between layers can be estimated a priori to printing using a slicer. The term T₀ can be the input temperature, represented by the meltpool temperature captured by the TEP signature.

After the temperature of each node is obtained, convective and radiative thermal losses can be included for the nodes on the top surface of each layer in Eqn. (8). Finally, step 4 can include repeating step 3 until the part is built.

The graph theory approach can converge 5 to 10-times faster than FE analysis, and the predictions can be within 5% (e.g., mean absolute percentage error, MAPE) of experimental measurements. The computationally efficient nature of the graph theory approach can facilitate computation of the thermal history within a 1/10^{th} of the time required to build a part.

The graph theory approach can be verified with finite element, finite difference, and exact analytical Green's functions-based solution for benchmark 1D and 3D heat transfer problems. The graph theory approach can also be applied to laser powder bed fusion-processed parts. The graph theory approach can also be verified with experimental data obtained during laser powder bed fusion. Two types of stainless steel (e.g., 316L) parts can be built build and surface temperature data can be obtained using an infrared thermal camera (e.g., staring configuration). The graph theory predictions can further be validated with Goldak's double ellipsoid model. For reaching a similar level of experimental error (5%, MAPE) the graph theory approach can converge within 30% of the time of FE analysis. Computational strategies can also be implemented to scale the graph theory approach for a large volume, practical stainless steel (e.g., 316L) impeller-shaped (e.g., Φ 160 mm×25 mm height), and the thermal history can be predicted using graph theory via experimental in-situ infrared thermography data. For a similar level of prediction error (<5%, MAPE) the graph theory approach can converge within 10 minutes compared to 4 hours for FE modeling. In context, the build time was 16 hours. Graph theory predictions can also be correlated with process failures (e.g., recoater crash) and microstructure evolved for different parts that can be simultaneously on an open architecture LPBF system. An in-situ infrared thermal camera can be used to measure the surface temperature distribution. During a 10-hour build, the graph theory approach can converge within 5 minutes, and the predicted thermal history can be correlated with the microstructure evolved (e.g., grain size and porosity), and process failures, such as recoater crash.

### Section 5: The Digital Twin Approach to Detect Flaw Formation

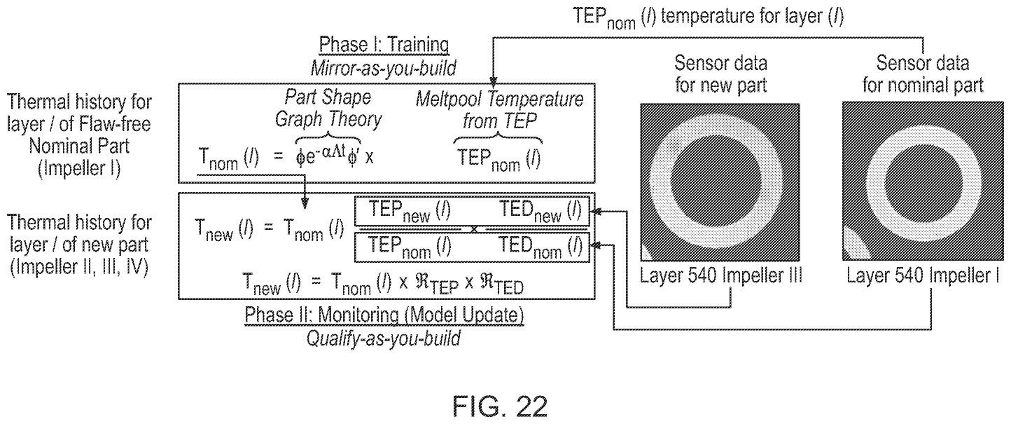

FIG. 22 depicts the two phases of the digital twin approach for detecting flaw formation. The approach for detecting flaw formation based on integrating the graph theory model with in-situ sensor data has two phases: Phase I—training phase, termed mirror-as-you-build, and Phase II—monitoring or update phased, termed qualify-as-you-build. In Phase I, a baseline thermal history for a nominal flaw-free part can be established (Tₙₒₘ). The thermal history Tₙₒₘ can be a function of the part shape (graph theory) and the meltpool temperature from the TEP signature. In Phase II, the thermal history of a new part T_{new} can be obtained by instantaneously updating the thermal history of the nominal-flaw free part T_{now} and the streaming data for the new part.

In other words, an analogy can be made with statistical process control as follows. In Phase I, termed mirror-as-you-build, the temperature distribution (thermal history) of the flaw-free condition can be predicted using the graph theory approach. The graph theory model can be trained (calibrated) to predict the thermal history of an impeller produced under ideal conditions. As described throughout the illustrative example in the present disclosure, Impeller I can represent the flaw-free condition. The TEP signature for Impeller I can be incorporated in the graph theory model. Thus, Phase I can capture the common cause variation in the build process on account of the part shape. Its layer-by-layer thermal history can be represented as Tₙₒₘ(l) for each layer l.

In Phase II, termed qualify-as-you-build, the process can be monitored continually to detect and isolate special cause variation on account of process drifts and intrusions that can also be identified. For the illustrative example described throughout this disclosure, the thermal trends for a new part, T_{new}(l), which can be example Impellers II, III, and III, can be predicted by instantaneously updating the thermal history of the nominal condition Tₙₒₘ (l) (Impeller I) based on their corresponding real-time TEP and TED signatures. A process drift, symptomatic of an incipient flaw can be indicated if the thermal history of a new part T_{new}(l) part deviates considerably from the thermal history of the nominal flaw-free Impeller I, Tₙₒₘ(l).

The aim of Phase 1 can be to obtain thermal history for the nominal (flaw-free) state. Phase I therefore can capture common cause variation in the thermal history resulting from the part shape. The thermal history of the nominal (flaw-free) part (e.g., Impeller I) obtained from graph theory can be written as,

$${\overbrace{{T}_{nom} ( x , y , z , t )}}^{Part temperature} = {\overbrace{ϕ {e}^{- α Λ t} {ϕ}^{′}}}^{Part Shape} \times {\overbrace{{T}_{o}}}^{Input temperature .} \qquad ( 17 )$$

On the LHS, Tₙₒₘ (x, y, z, t) can be the temperature of the nominal flaw-free part at a particular location x, y, z and time instant t. On the RHS can be the input temperature Tₒ.

For detection of anomalies it can be necessary to consider the input temperature at a small time scale. In other words, instantaneous meltpool temperature, as opposed to steady state temperature can be incorporated into the model described herein since the instantaneous meltpool temperature can govern microstructure evolution and flaw formation. Not factoring the local meltpool behavior may lead to erroneous detection of flaw formation.

The meltpool temperature can be obtained from the TEP sensor data. This meltpool thermal information from the nominally processed part data can be integrated into the original heat diffusion equation as follows.

$${T}_{nom} ( x , y , z , t ) = ϕ {e}^{- α Λ t} {ϕ}^{′} \times {TEP}_{nom} ( x , y , z , t ) \qquad ( 18 )$$

In Eqn. (18), t can be time between layers (TBL). As noted previously in Sec. 3, in the context of FIG. 8, the TBL may not be constant, but can vary in proportion to the scanned surface area. Representing the effect of part shape at layer l as [symbol] , and the temperature at location x, y, z at time t at layer l can be written as TEPₙₒₘ (l),

$${T}_{nom} ( l ) = 𝕊 \times {TEP}_{nom} ( l ) \qquad ( 19 )$$

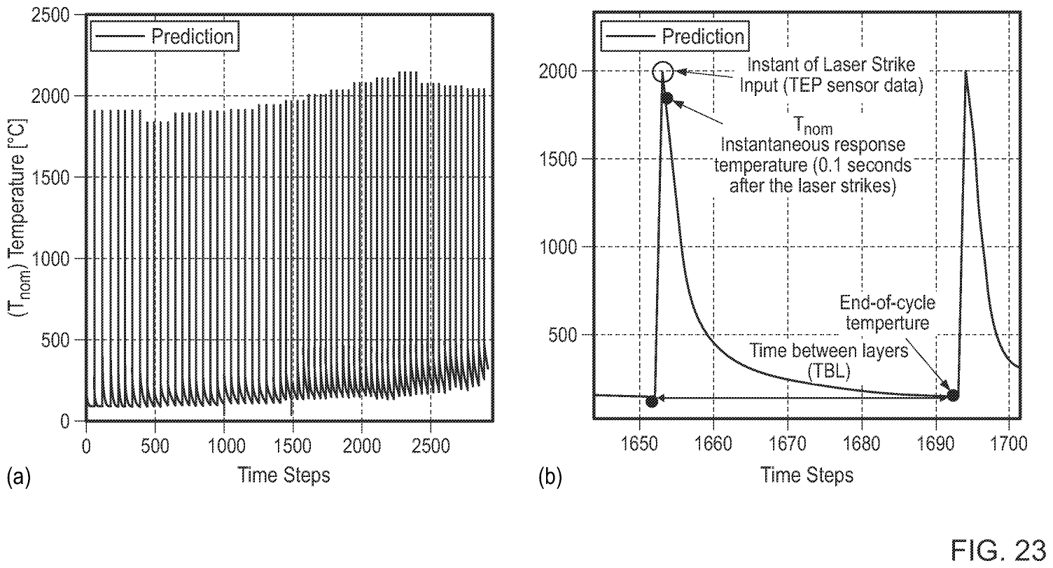

The thermal history Tₙₒₘ for the nominal part can be obtained as a consequence of Eqn. (19), which is depicted in FIG. 23(a), zoomed in sections of which are shown in FIG. 23(b). These temperature trends can be plotted for the location shown in FIG. 14 for the flaw-free impeller (Impeller I).

FIG. 23 includes graphical depictions of thermal simulation of a part with input from a TEP sensor. In particular, FIG. 23(a) shows output for an entire 845 layers of part and FIG. 23(b) shows a zoomed-in section of the thermal history, depicting two peaks resulting from the laser strike, and a plateau at the end of a layer (end-of-cycle temperature). In the illustrative example described throughout this disclosure, simulation output can be sampled 0.1 seconds after the laser strike, where this output can be the Tₙₒₘ temperature.

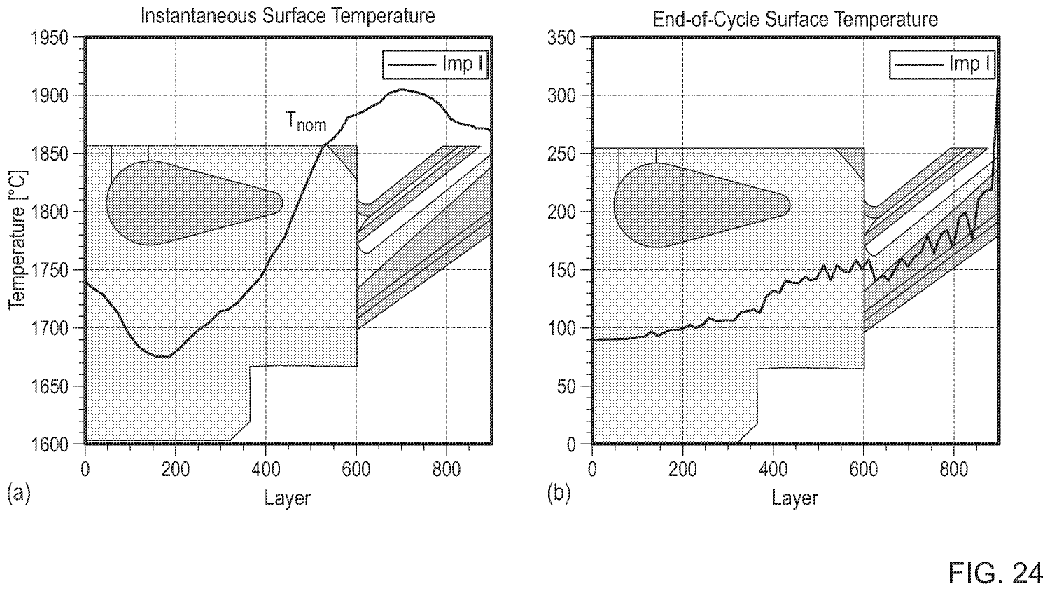

In the cooling curves in FIG. 23, two distinctive aspects can be observed. The first is transient temperature instantly after the laser strikes the sampled area, and the steady state temperature reached after the end-of-cycle captured when the laser has finished processing a layer. Once the cooling curve is obtained, the temperature response after 0.1 seconds following the laser strike can be extracted. This output temperature Tₙₒₘ can be intended to capture the surface temperature immediately following a laser strike, called the transient or instantaneous temperature. The reasoning for selecting the transient (instantaneous) temperature is provided in terms of FIG. 24.

FIG. 24 includes graphical depictions of thermal history of an entire part sampled at 0.1 seconds after a laser strikes the part (e.g., refer to FIG. 24(a)) and at the end-of-cycle temperature (e.g., refer to FIG. 24(b)). The instantaneous surface temperature in FIG. 24(a) can be evocative of short-time process dynamics dominated by laser-meltpool interactions. The end-of-cycle temperature trends in FIG. 24(b) can be influenced by geometry of the part.

In other words, in FIG. 24, the response can be plotted for two different time scales following the laser strike. These are 0.1 sec after the laser strike, called instantaneous surface temperature, and after the layer is deposited, called end-of-cycle temperature. Comparing FIGS. 24(a) and 24(b), it can be evident that as the simulation output is sampled closer to the end-of-cycle steady state, the effect of part geometry on the thermal history dominates, and the local temperature variations can be occluded, which can be critical to detect process flaws. Therefore, the output temperature obtained after 0.1 seconds of the laser strike can represent Tₙₒₘ(l) in the disclosed techniques.

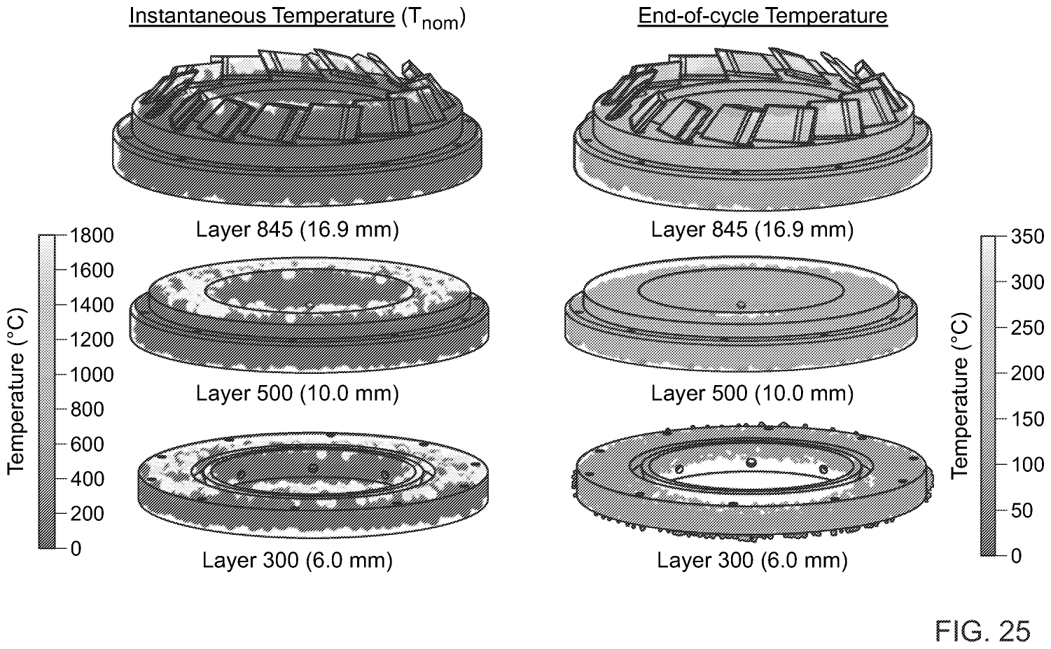

FIG. 25 depicts a comparison of simulation results when using instantaneous temperature and the end-of-cycle temperature. The end-of-cycle temperature distribution (right) can be the so-called steady state, as the part has cooled sufficiently. The instantaneous temperature distribution (left) can capture the local differences in temperature.

The consequence of using steady state versus the instantaneous surface temperature is further visualized in FIG. 25 in terms of 3D temperature distribution obtained from graph theory. The local temperature differences that are evident in the graph theory simulation via the instantaneous temperature Tₙₒₘ can be attenuated in the steady state thermal profile.

The aim of Phase II can be to monitor part quality in real-time. Phase II can use the thermal history of the nominal flaw-free Tₙₒₘ part obtained in Phase I in Eqn. (19) to detect flaw formation when building a new part of the same shape. The monitoring step may not require re-computation of the thermal history using the graph theory approach, and may be nearly instantaneous.

This concept can be based on updating the already existing thermal history predictions (Tₙₒₘ(l)) for Impeller I obtained in Phase 1 contingent on the meltpool temperature at layer/for the new part, TEP_{new}(l).

The rational is that the thermal of a new parts, TEP_{new}(l) (for Impeller II, III, and IV), can be liable to contain both the common cause variation from Impeller I and special cause variation from faults. Flaw formation in new parts can be detected by comparing the thermal history of the new part TEP_{new}(l) with the thermal history of the nominal part TEPₙₒₘ(l).

The approach can be as follows, at the outset temperature T_{new} can be written at the sampled location at layer/using the same reasoning in Phase I, Eqn. (19).

$${T}_{new} ( l ) = 𝕊 \times {TEP}_{new} ( l ) \qquad ( 20 )$$

The term [symbol] can be obtained from Eqn. (19),

$$as = \frac{{T}_{nom} ( l )}{{TEP}_{nom} ( l )} .$$

Substituting for [symbol] into Eqn. (20),

$${T}_{new} ( l ) = {T}_{nom} ( l ) \times \frac{{TEP}_{new} ( l )}{{TEP}_{nom} ( l )} \qquad ( 21 )$$

The above equation can be simplified on writing

$${TEP ( l )}_{} = \frac{{TEP}_{new} ( l )}{{TEP}_{nom} ( l )}$$

$${T}_{new} ( l ) = {T}_{nom} ( l ) \times {TEP ( l )}_{} \qquad ( 22 )$$

In other words, the thermal history of a new part at layer l can be a function of the thermal history of the nominal part Tₙₒₘ(l), and relative change [symbol] _{TEP(l)} in the in-process meltpool temperature of the new part TEP_{new}(l) at layer/compared to the nominal part TEPₙₒₘ(l).

Next, the effect input energy density of the laser captured by the TED sensor measurements can be incorporated as follows,

$${T}_{new} ( l ) = {T}_{nom} ( l ) \times {TEP}_{} \times \frac{{TED}_{new} ( l )}{{TED}_{nom} ( l )} = {T}_{nom} ( l ) \times {TEP}_{} \times {TED}_{} \qquad ( 23 )$$

Since, the thermal history of the nominal part TEPₙₒₘ(l) can be obtained in Phase I, the computation time in obtaining T_{new}(l) can be infinitesimal. The computational effort that is expended to obtain in TEPₙₒₘ(l) in Phase I, as demonstrated below, can take less than 5 minutes.

The graph theory approach can require calibration of three model parameters, namely, the number of nodes n, the number of layers (meta layers or superlayers) that are considered to be deposited at the same time for computational efficiency, and the gain factor g. In the illustrative example described throughout this disclosure, model parameters are detailed in Table 4.

TABLE 4
The effect of node density superlayer thickness
on computation time. In this work we selected

| Material Properties | Values |
|---|---|
| Convection coefficient part to | 1 × 10⁻⁵ |
| powder, h_{w} [W · m⁻² · C] | |
| Convection coefficient substrate | 1.0 × 10⁻² |
| (sink), hₛ [W · m⁻² · C] | |
| Thermal diffusivity (α) [m²/s] | 3.0 × 10⁻⁶ |
| Density, ρ [kg/m³] | 8,190 |
| Melting Point (T₀) [C.] | 1,800 |
| Ambient chamber temperature, Tₚ [C.] | 90 |
| Simulation Parameters | Values |
| Characteristic length [mm] | 2 |
| Fixed number of nearest neighbors (η) | 10 |
| Superlayer thickness [mm] | 0.25 (12 actual layers) |
| Gain factor (g) [m⁻²] | 2 × 10⁵ |
| Computational hardware | Intel Core i7-6700 CPU, |
| | @3.40 GHz with 32 GB RAM. |

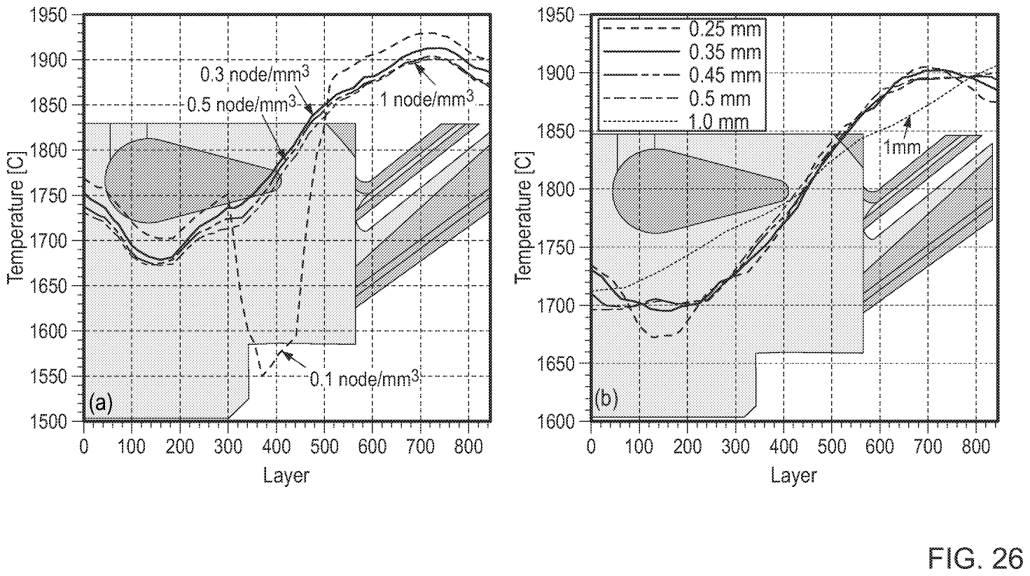

FIG. 26 includes graphical depictions of convergence with effect of node density with super layer thickness fixed at 0.25 mm and effect of super layer thickness with node density fixed at 0.5 nodes·m⁻³. The number of nodes, can be tuned in terms of node density (e.g., number of nodes per unit volume). The number of nodes and the super layer thickness can be optimized for Impeller I. Shown in FIGS. 26(a) and 26(b) are convergence characteristics of the graph theory model as a function of the node density and superlayer thickness, respectively. Increasing the number of nodes and reducing the superlayer thickness effects can improve prediction accuracy at the cost of computational efficiency.

The effect of the node density and super layer thickness is reported in

Table 5. In the illustrative example described throughout this disclosure, the trends can converge within 5 minutes with number of nodes set at 0.5 nodes·mm⁻³, and superlayer thickness of 0.25 mm.

TABLE 5
The effect of node density superlayer thickness
on computation time. In this work we selected

| Node Density | | Total number | Simulation |
|---|---|---|---|
| [nodes · mm⁻³] | Super Layer [mm] | of Nodes | Time [s] |
| 0.1 | 0.25 (selected) | 1407 | 23 |
| 0.3 | | 4083 | 121 |
| 0.5 (selected) | | 6771 | 393 |
| 1 | | 13748 | 2393 |
| 0.5 | 0.25 | 6771 | 393 |
| | 0.35 | | 277 |
| | 0.45 | | 181 |
| | 0.5 | | 179 |

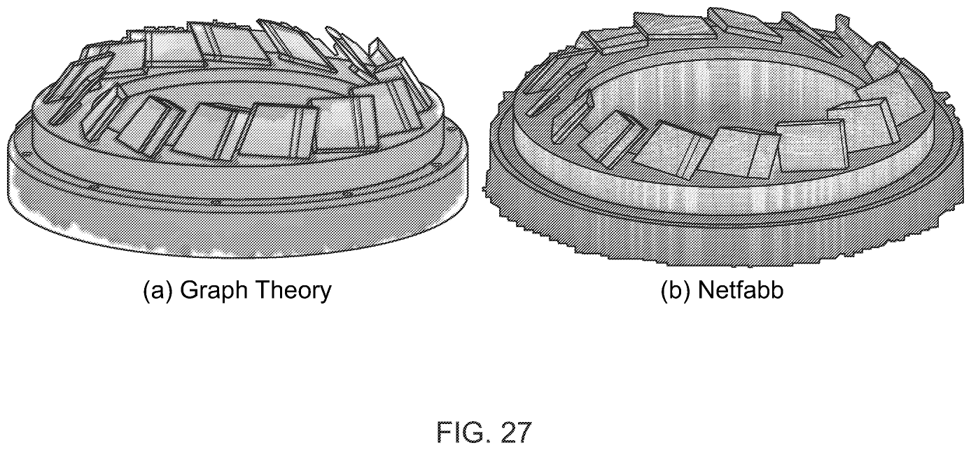

FIG. 27 depicts graph theory-derived thermal history predictions compared with commercial Netfabb output. As a qualitative comparison, the graph theory approach can be corroborated with commercial Netfabb software. As evidenced from FIG. 27, both the graph theory and Netfabb can predict retention of heat in the fin region of an impeller. The graph theory predictions shown in FIG. 27 can be obtained by assuming a steady-state end-of-cycle melting temperature Tₒ of ˜1370 C, instead of instantaneous meltpool temperature used for flaw monitoring.

### Section 6: Results

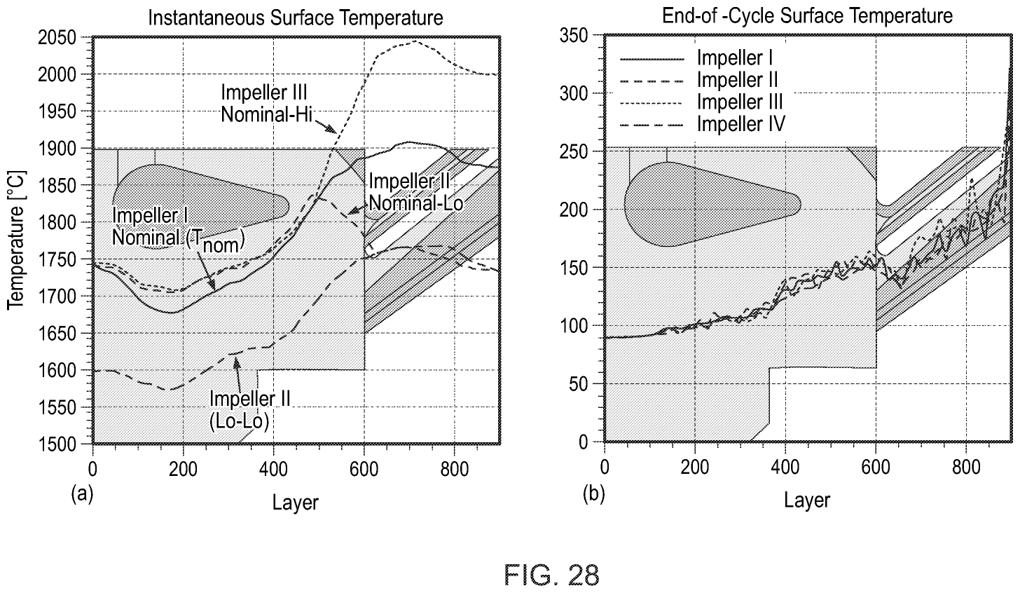

FIG. 28 includes graphical depictions of thermal history for the four impellers of FIG. 5 when instantaneous surface temperature is sampled (e.g., refer to FIG. 28(a)) versus when end-of-cycle temperature is sampled (e.g., refer to FIG. 28(b)). As shown in FIG. 28(a), surface temperature is sampled following 0.1 seconds after the laser strike. The thermal trends diverge significantly corresponding to change in the laser power. As shown in FIG. 28(b), on the contrary, when the thermal simulation is sampled at the end-of-cycle, the difference between the four impellers may not be evident. These results can be obtained with node density n=0.5 nodes/mm³ and super layer thickness of 0.5 mm.

As described in reference to Eqn. (23), the meltpool information in the form of TEP and TED signatures can be incorporated into the graph theory thermal model. FIG. 28(a) shows the instantaneous surface temperature predictions for the four impellers as a function of layer height, the instantaneous surface temperature (Tₙₒₘ) being the local response following 0.1 sec after the laser strikes the sampled area. FIG. 28(b) shows the surface temperature predictions at the end-of-cycle.

Comparing FIGS. 28(a) and 28(b) underscores the importance of considering the instantaneous surface temperature as opposed to the end-of-cycle temperature. The instantaneous surface temperature in FIG. 28(a), for example, diverges significantly for Impellers II, III, and IV, corresponding to the layers where the laser power is changed. A comparison of FIG. 28(a) and FIG. 15 also highlights utility of the digital twin approach: process anomalies that can be difficult to discern from the TEP sensor data alone can be manifested when the sensor signatures are combined with a physical model. The end-of-cycle temperature therefore may not capture and identify process parameter variations as the geometry primarily can dictate the thermal history of the part.

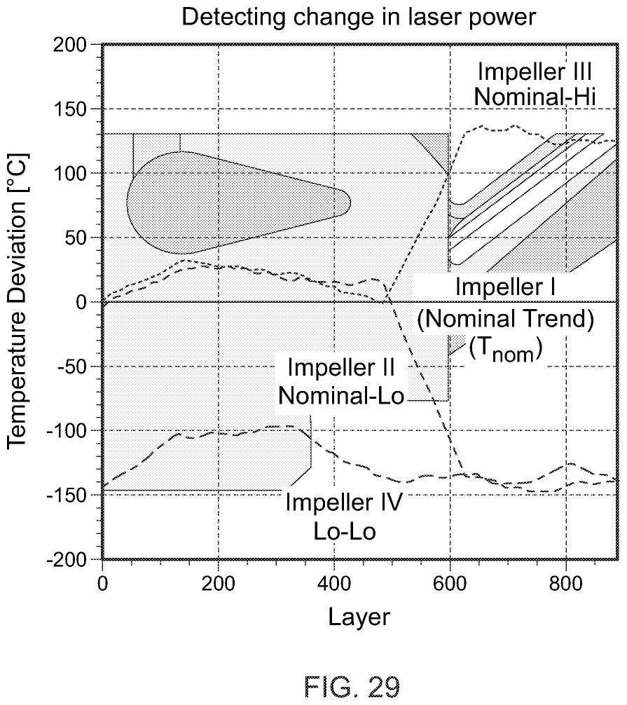

FIG. 29 is a graphical depiction of temperature deviations from the nominal Impeller 1 as used to detect process drifts and embedded flaws. As the laser power in the processing of the fin region changes for Impeller II and III, the layer temperature can deviate significantly from that of the nominal flaw-free Impeller I. Likewise, the temperature trends for Impeller IV, which can be produced at low power (125 W) can be significantly different than the nominal impeller I. Temperature trends relative to Impeller I can be sampled at locations without embedded flaws. The trends for Impeller II and III diverge significantly before the fin region where the laser power can be changed from 265 W to 125 W and 195 W respectively.

Both FIGS. 28 and 29 refer to case I for detecting process drifts.

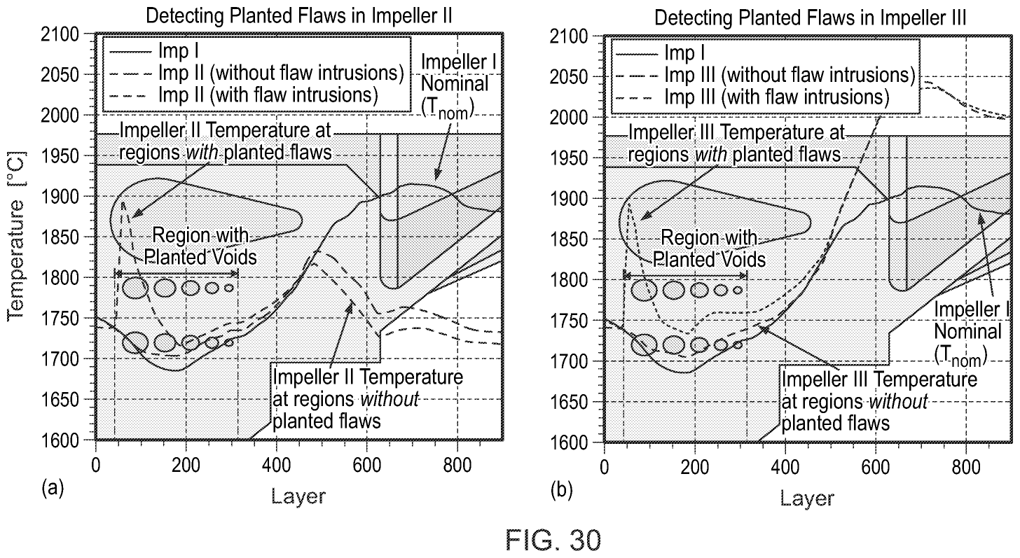

FIG. 30 includes graphical depictions of temperature response for Impellers II and III sampled at sections where flaws were planted. Accordingly, in FIGS. 30(a) and 30(b), the digital twin approach can be used for detecting implanted flaws in Impeller II and Impeller III, respectively. FIG. 30(a) demonstrates not only a distinct difference in thermal history of Impeller I and Impeller II, but also in the thermal history of sections with and without implanted flaws. There can be a noticeable increase in temperature in the region of embedded flaws introduced in the parts in comparison to thermal trends for flaw-free regions.

The deviation from the thermal trends of the flaw-free region can be largest at a location corresponding to biggest embedded flaw of Φ 0.5 mm. A similar difference can be noted in the case of Impeller III in FIG. 30(b). These anomalies in the thermal trends can make it possible to identify when malicious intrusions have occurred, as well as pinpoint which regions have been targeted.

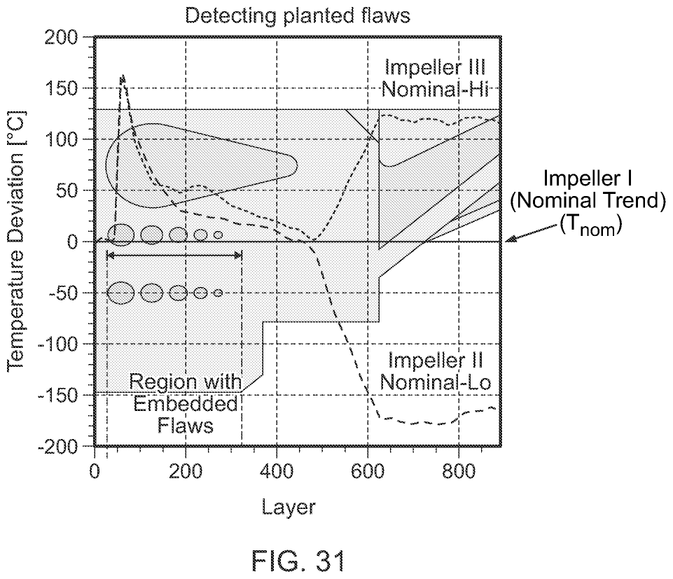

FIG. 31 is a graphical depiction demonstrating a large deviation from nominal temperature trends as observed in a region where flaws are embedded in the Impellers II and III. Shown are relative temperature trends sampled in the region with planted (embedded) flaws. These trends diverge significantly in the region where the flaws are embedded.

Both FIGS. 30 and 31 refer to case II for detecting planted flaws.

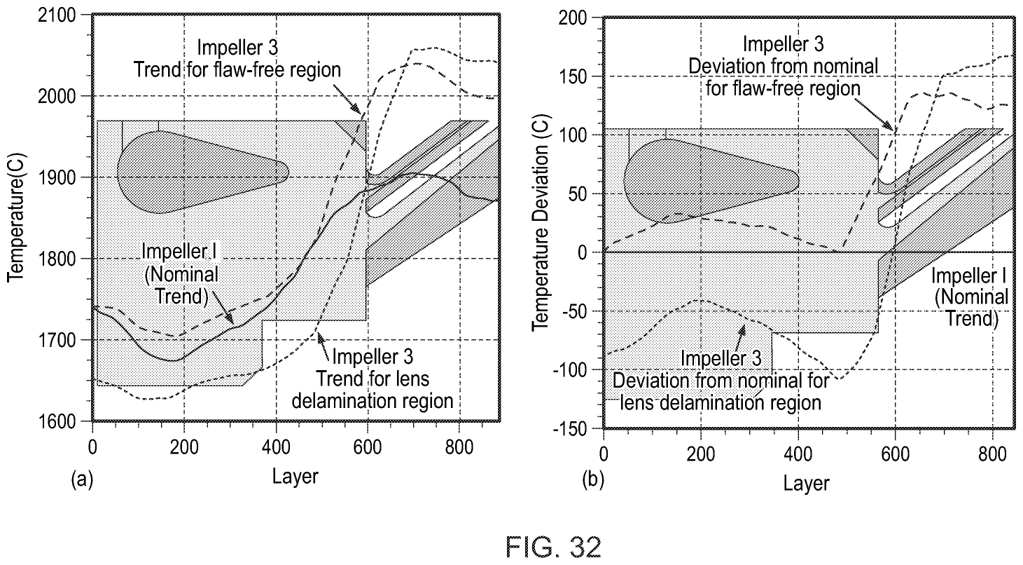

FIG. 32 includes graphical depictions of thermal history trends for Impeller III sampled from a lens delamination region compared to thermal history trends for a flaw-free region (e.g., refer to FIG. 32(a)). Shown also is the trend for the nominal, flaw-free Impeller I. FIG. 32(b) demonstrates a large deviation from the nominal part for Impeller III for regions where there are no flaws and where lens delamination can be observed.

In other words, an implementation of the digital twin approach for detecting lens delamination is shown in FIG. 32. Plotted in FIG. 32(a) are thermal history trends for Impeller III with the TEP data sampled in the region with delamination. Also overlaid are thermal trends for Impeller III sampled for the flaw-free region, as well as the thermal history for Impeller I.

The deviation in Impeller III trends from Impeller I are reported in FIG. 32(b). These results demonstrate that the digital twin approach can capture the difference in temperature trends that can be symptomatic of flaw formation between different impellers, but also within the same impeller on account of machine faults. FIG. 32, therefore, refers to case III, which is directed to detecting machine flaws (e.g., f-θ lens delamination).

### Section 7: Conclusion

The disclosed techniques provide, in the context of the LPBF process and other additive manufacturing processes, that combining (twinning) real-time in-process sensor data with fast and accurate thermal models can facilitate precise and interpretable detection of flaw formation and process faults (deviations or drifts).

As described throughout this disclosure, four stainless steel (316L) impeller-shaped parts can be built simultaneously on a EOS M290 LPBF system to validate the digital twin approach. These impellers can measure Φ60 mm×16.9 mm in height, can consist of 845 layers and can use approximately 16.5 hours to complete. During the build, the process can be monitored continuously using an array of three photodetectors integrated into the laser path. Signals obtained from the sensor array can be processed to create two types of measurements, namely TEP and TED. The TEP signature can be correlated to the meltpool temperature, while TED can capture the broadband chamber radiation.

The first of these four impellers, Impeller I, can be produced under optimal processing parameters: nominally flaw-free processing conditions (laser power of 195 W). Two other impellers (Impeller II and III) can be processed under differing laser power settings that can be changed during the build to mimic process faults. For Impeller II, the laser power can be changed from 195 W to 125 W. For Impeller III, the laser power can be changed from 195 W to 265 W. A fourth impeller, Impeller IV, can be processed under reduced laser power of 125 W. Further, voids can be embedded into Impellers II, III, and IV to imitate flaw formation caused due to malicious intrusions in the process. A third type of flaw, evocative of flaws created due to machine failures called lens delamination, can also be introduced in Impeller III, which can lead to reduced energy in the melting of specific regions.

The impellers can then be characterized with non-destructive X-ray computed tomography (XCT). These can be subsequently cross-sectioned, polished, and etched in preparation for analysis using optical micrography, scanning electron microscopy (SEM), and electron backscatter diffraction (EBSD). The XCT analysis can reveal that flaw volume ratio in the sample produced under nominal processing conditions (Impeller I) can be under 0.01 percent, while for the rest of the impellers the flaw volume ratio can be in the range of 0.08 percent to 0.11 percent. The optical and scanning electron microscopy can reveal presence of lack-of-fusion flaw formation in the functionally critical fin region of Impeller II, III, and IV. Differences in the microstructure (grain size and texture) and orientation can also become evident. Hence, a change in the processing conditions can be liable to impact the functional integrity of an additive manufacturing-produced part.

The thermal model used and described throughout this disclosure can be based on the concept of heat diffusion on graphs: graph theory, which can be several-fold faster and more efficient than FE analysis. The graph theory approach can be used to predict temperature distribution at the part level (thermal history). The graph theory simulation can converge within 5 minutes compared to 16.5 hour build time.

The TEP and TED sensor signatures can be coupled into the graph theory model. In this manner, the part-level or macro-scale thermal history of the part predicted from graph theory can be complemented with meltpool-level phenomena measured using in-process sensors.

A real-time monitoring schema can be developed to detect changes in the sensor signatures symptomatic of an incipient fault. Thus, defect formation can be monitored in real-time by updating the graph theory layer-by-layer as TEP and TED measurements are received. The proposed digital twin approach can capture all the three types flaw formation aspects in an unambiguous manner. In some implementations, the graph theory approach can be used with microstructure modeling (cellular automata) to predict microstructure evolution.

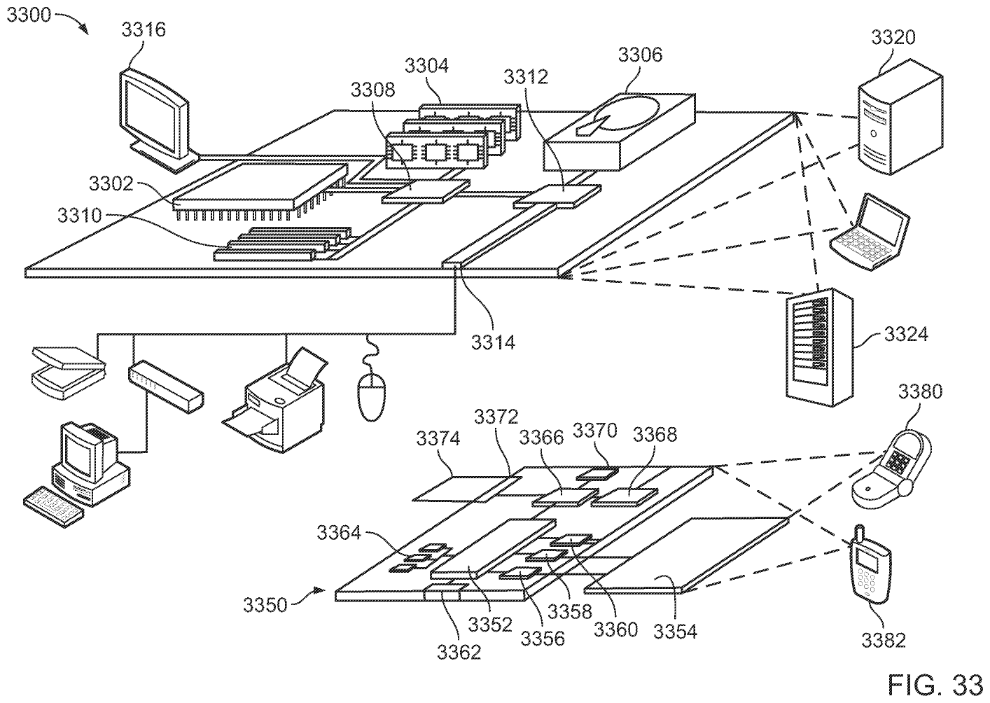

FIG. 33 shows an example of a computing device 3300 and an example of a mobile computing device that can be used to implement the techniques described here. The computing device 3300 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 3300 includes a processor 3302, a memory 3304, a storage device 3306, a high-speed interface 3308 connecting to the memory 3304 and multiple high-speed expansion ports 3310, and a low-speed interface 3312 connecting to a low-speed expansion port 3314 and the storage device 3306. Each of the processor 3302, the memory 3304, the storage device 3306, the high-speed interface 3308, the high-speed expansion ports 3310, and the low-speed interface 3312, are interconnected using various busses, and can be mounted on a common motherboard or in other manners as appropriate. The processor 3302 can process instructions for execution within the computing device 3300, including instructions stored in the memory 3304 or on the storage device 3306 to display graphical information for a GUI on an external input/output device, such as a display 3316 coupled to the high-speed interface 3308. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 3304 stores information within the computing device 3300. In some implementations, the memory 3304 is a volatile memory unit or units. In some implementations, the memory 3304 is a non-volatile memory unit or units. The memory 3304 can also be another form of computer-readable medium, such as a magnetic or optical disk.

The storage device 3306 is capable of providing mass storage for the computing device 3300. In some implementations, the storage device 3306 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 3304, the storage device 3306, or memory on the processor 3302.

The high-speed interface 3308 manages bandwidth-intensive operations for the computing device 3300, while the low-speed interface 3312 manages lower bandwidth-intensive operations. Such allocation of functions is exemplary only. In some implementations, the high-speed interface 3308 is coupled to the memory 3304, the display 3316 (e.g., through a graphics processor or accelerator), and to the high-speed expansion ports 3310, which can accept various expansion cards (not shown). In the implementation, the low-speed interface 3312 is coupled to the storage device 3306 and the low-speed expansion port 3314. The low-speed expansion port 3314, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 3300 can be implemented in a number of different forms, as shown in the figure. For example, it can be implemented as a standard server 3320, or multiple times in a group of such servers. In addition, it can be implemented in a personal computer such as a laptop computer 3322. It can also be implemented as part of a rack server system 3324. Alternatively, components from the computing device 3300 can be combined with other components in a mobile device (not shown), such as a mobile computing device 3350. Each of such devices can contain one or more of the computing device 3300 and the mobile computing device 3350, and an entire system can be made up of multiple computing devices communicating with each other.

The mobile computing device 3350 includes a processor 3352, a memory 3364, an input/output device such as a display 3354, a communication interface 3366, and a transceiver 3368, among other components. The mobile computing device 3350 can also be provided with a storage device, such as a micro-drive or other device, to provide additional storage. Each of the processor 3352, the memory 3364, the display 3354, the communication interface 3366, and the transceiver 3368, are interconnected using various buses, and several of the components can be mounted on a common motherboard or in other manners as appropriate.

The processor 3352 can execute instructions within the mobile computing device 3350, including instructions stored in the memory 3364. The processor 3352 can be implemented as a chipset of chips that include separate and multiple analog and digital processors. The processor 3352 can provide, for example, for coordination of the other components of the mobile computing device 3350, such as control of user interfaces, applications run by the mobile computing device 3350, and wireless communication by the mobile computing device 3350.

The processor 3352 can communicate with a user through a control interface 3358 and a display interface 3356 coupled to the display 3354. The display 3354 can be, for example, a TFT (Thin-Film-Transistor Liquid Crystal Display) display or an OLED (Organic Light Emitting Diode) display, or other appropriate display technology. The display interface 3356 can comprise appropriate circuitry for driving the display 3354 to present graphical and other information to a user. The control interface 3358 can receive commands from a user and convert them for submission to the processor 3352. In addition, an external interface 3362 can provide communication with the processor 3352, so as to enable near area communication of the mobile computing device 3350 with other devices. The external interface 3362 can provide, for example, for wired communication in some implementations, or for wireless communication in other implementations, and multiple interfaces can also be used.

The memory 3364 stores information within the mobile computing device 3350. The memory 3364 can be implemented as one or more of a computer-readable medium or media, a volatile memory unit or units, or a non-volatile memory unit or units. An expansion memory 3374 can also be provided and connected to the mobile computing device 3350 through an expansion interface 3372, which can include, for example, a SIMM (Single In Line Memory Module) card interface. The expansion memory 3374 can provide extra storage space for the mobile computing device 3350, or can also store applications or other information for the mobile computing device 3350. Specifically, the expansion memory 3374 can include instructions to carry out or supplement the processes described above, and can include secure information also. Thus, for example, the expansion memory 3374 can be provide as a security module for the mobile computing device 3350, and can be programmed with instructions that permit secure use of the mobile computing device 3350. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 3364, the expansion memory 3374, or memory on the processor 3352. In some implementations, the computer program product can be received in a propagated signal, for example, over the transceiver 3368 or the external interface 3362.

The mobile computing device 3350 can communicate wirelessly through the communication interface 3366, which can include digital signal processing circuitry where necessary. The communication interface 3366 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 3368 using a radio-frequency. In addition, short-range communication can occur, such as using a Bluetooth, WiFi, or other such transceiver (not shown). In addition, a GPS (Global Positioning System) receiver module 3370 can provide additional navigation- and location-related wireless data to the mobile computing device 3350, which can be used as appropriate by applications running on the mobile computing device 3350.

The mobile computing device 3350 can also communicate audibly using an audio codec 3360, which can receive spoken information from a user and convert it to usable digital information. The audio codec 3360 can likewise generate audible sound for a user, such as through a speaker, e.g., in a handset of the mobile computing device 3350. Such sound can include sound from voice telephone calls, can include recorded sound (e.g., voice messages, music files, etc.) and can also include sound generated by applications operating on the mobile computing device 3350.

The mobile computing device 3350 can be implemented in a number of different forms, as shown in the figure. For example, it can be implemented as a cellular telephone 3380. It can also be implemented as part of a smart-phone 3382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for detecting flaws during an additive manufacturing process, the method comprising:
accessing, by a computing system, results of a simulation of a computer-modelled part representing a physical part to be formed using the additive manufacturing process, wherein the simulation of the computer-modelled part comprises a thermal history model for the computer-modelled part; and
during a run-time formation of the physical part by the additive manufacturing process:
receiving, by the computing system and from one or more sensor devices, real-time sensor data of temperature values for nodes within a plurality of regions of the physical part that is formed using the additive manufacturing process as each of the plurality of regions is formed for the physical part, the regions of the physical part each having densities of the respective nodes, wherein the plurality of regions of the physical part correspond to respective regions of the computer-modelled part;
determining, by the computing system and for each region of the plurality of regions of the physical part as the region is formed in the physical part, a deviation between the real-time sensor data of temperature values for the nodes within the region of the physical part and temperature values of the thermal history model for the computer-modelled part; and
identifying, by the computing system, one or more flaws in the physical part based on determining that the deviation satisfies criteria indicating a flaw.

2. The computer-implemented method of claim 1, wherein the simulation of the computer-modelled part included a computer performing the following:
accessing, by the computer, the computer-modelled part representing the physical part to be formed using the additive manufacturing process;
populating, by the computer, first nodes within a first region of the computer-modelled part with temperature values, such that each of the first nodes has a corresponding temperature value, the first region of the computer-modelled part having a first density of the first nodes, the first region of the computer-modelled part being proximal a surface of the computer-modelled part at which material is added to the computer-modelled part during a simulation of the additive manufacturing process;
populating, by the computer, second nodes within a second region of the computer-modelled part with temperature values, such that each of the second nodes has a corresponding temperature value, the second region of the computer-modelled part having a second density of the second nodes that is less than the first density of the first nodes in the first region of the computer-modelled part, the second region of the computer-modelled part being distal the surface of the computer-modelled part at which material is added to the computer-modelled part during the simulation of the additive manufacturing process;
removing, by the computer, first nodes from part of the first region that is proximate the second region of the computer-modelled part, so that the part of the first region that is proximate the second region becomes part of the second region and has the second density of nodes;
simulating, by the computer as part of the simulation of the additive manufacturing process, adding material on the surface of the computer-modelled part to form a new layer of the computer-modelled part, the new layer of the computer-modelled part being part of the first region and having first nodes that are distributed according to the first density;
populating, by the computer, the first nodes within the new layer of the computer-modelled part with temperature values, such that each of the first nodes within the new layer of the computer-modelled part has a corresponding temperature value; and
generating, by the computer, the thermal history model for the computer-modelled part, wherein the thermal history model includes the temperature values for each of the first and second nodes in the regions of the computer-modelled part.

3. The computer-implemented method of claim 1, wherein the additive manufacturing process comprises a laser powder bed fusion (LPBF) additive manufacturing process.

4. The computer-implemented method of claim 1, wherein the real-time sensor data includes one or more temperature values of a laser-material interaction zone of the physical part.

5. The computer-implemented method of claim 1, wherein the one or more sensor devices include an array of photodetectors located co-axial to a path of a laser that is used to build the physical part during the additive manufacturing process.

6. The computer-implemented method of claim 2, wherein at least one of the first region, the second region, and the new layer of the computer-modelled part is (i) a location without artificially planted flaws, (ii) a location where artificial flaws were planted, or (iii) a location where lens delamination was suspected.

7. The computer-implemented method of claim 1, wherein the thermal history model of the computer-modelled part represents temperature values of the computer-modelled part when the computer-modelled part is in a flaw-free condition.

8. The computer-implemented method of claim 2, wherein the temperature value for each of the first and second nodes is an instantaneous meltpool temperature for the computer-modelled part.

9. The computer-implemented method of claim 1, wherein the real-time sensor data includes output temperature values detected by the one or more sensor devices a threshold period of time after a laser strikes the physical part.

10. The computer-implemented method of claim 1, wherein the threshold period of time is 0.1 seconds.

11. The computer-implemented method of claim 1, wherein the computer-modelled part and the physical part are a same shape.

12. The computer-implemented method of claim 1, further comprising updating, by the computing system, temperature values in the thermal history model of the computer-modelled part at one or more of the regions in the computer-modelled part with the real-time sensor data of corresponding one or more of the plurality of regions in the physical part.

13. A computerized system, comprising:
one or more processors; and
one or more computer-readable devices including instructions that, when executed by the one or more processors, cause the computerized system to perform operations that include:
accessing results of a simulation of a computer-modelled part representing a physical part to be formed using the additive manufacturing process, wherein the simulation of the computer-modelled part comprises a thermal history model for the computer-modelled part; and
during a run-time formation of the physical part by the additive manufacturing process:
receiving, from one or more sensor devices, real-time sensor data of temperature values for nodes within a plurality of regions of the physical part that is formed using the additive manufacturing process as each of the plurality of regions is formed for the physical part, the regions of the physical part each having densities of the respective nodes, wherein the plurality of regions of the physical part correspond to respective regions of the computer-modelled part;
determining, for each region of the plurality of regions of the physical part as the region is formed in the physical part, a deviation between the real-time sensor data of temperature values for the nodes within the region of the physical part and temperature values of the thermal history model for the computer-modelled part; and
identifying one or more flaws in the physical part based on determining that the deviation satisfies criteria indicating a flaw.

14. The computerized system of claim 13, wherein the additive manufacturing process comprises a laser powder bed fusion (LPBF) additive manufacturing process.

15. The computerized system of claim 13, wherein the real-time sensor data includes one or more temperature values of a laser-material interaction zone of the physical part.

16. The computerized system of claim 13, wherein the one or more sensor devices include an array of photodetectors located co-axial to a path of a laser that is used to build the physical part during the additive manufacturing process.

17. The computerized system of claim 13, wherein the real-time sensor data includes output temperature values detected by the one or more sensor devices a threshold period of time after a laser strikes the physical part.

18. The computerized system of claim 13, wherein the computer-modelled part and the physical part are a same shape.

19. The computerized system of claim 13, wherein the operations further comprise updating temperature values in the thermal history model of the computer-modelled part at one or more of the regions in the computer-modelled part with the real-time sensor data of corresponding one or more of the plurality of regions in the physical part.

20. The computerized system of claim 13, wherein the thermal history model of the computer-modelled part represents temperature values of the computer-modelled part when the computer-modelled part is in a flaw-free condition.
